(19) United States
(12) Patent Application Publication
(10) Pub. No.: US 2026/0107243 A1
(43) Pub. Date: Apr. 16, 2026

(54) METHOD FOR DETECTION AND SL TERMINAL THEREOF

(71) Applicant: GUANGDONG OPPO MOBILE TELECOMMUNICATIONS CORP., LTD., Dongguan (CN)

(72) Inventors: Jinyu ZHANG, Dongguan (CN); Rongyi HU, Dongguan (CN)

(21) Appl. No.: 19/419,987

(22) Filed: Dec. 15, 2025

Related U.S. Application Data
(63) Continuation of application No. PCT/CN2023/112750, filed on Aug. 11, 2023.

(51) Int. Cl. H04W 56/00

(52) U.S. Cl. CPC H04W 56/0015

(57) ABSTRACT

Provided is a method for detection. The method is performed by a sidelink (SL) terminal, and includes: extending a detection period in a case where a first sampling result within the detection period does not satisfy a first condition, wherein the detection period is used for detecting a synchronization source via an unlicensed SL (SL-U).

### CROSS-REFERENCE TO RELATED APPLICATION

This application is a continuation application of international application No. PCT/CN2023/112750, filed on Aug. 11, 2023, the entire contents of which are incorporated herein by reference.

### TECHNICAL FIELD

The present disclosure relates to the field of sidelink (SL) communications, and in particular, relates to a method for detection and an SL device thereof.

### RELATED ART

One of the features that distinguish an SL from a Uu-link is the synchronization process. A terminal uses the global navigation satellite system (GNSS), cells, and other terminals as synchronization sources thereof, and selects or reselects a synchronization source based on a predetermined or configured synchronization source priority order. The terminal triggers transmission of an SL synchronization signal (SLSS) under a condition to expand a synchronization range, such that other terminals acquire synchronization information of the terminal.

### SUMMARY

The present disclosure provides a method for detection and an SL device thereof. The technical solutions are as follows.

In some embodiments of the present disclosure, a method for detection is provided. The method is performed by an SL terminal, and includes:
extending a detection time duration in a case where a first sampling result within the detection time duration does not satisfy a first condition,
wherein the detection time duration is used for detecting a synchronization source via an unlicensed SL (SL-U).

In some embodiments of the present disclosure, an SL terminal is provided. The SL terminal includes: a processor; a transceiver, connected to the processor; and a memory, configured to store one or more executable instructions of the processor, wherein the SL terminal is configured to load and execute the one or more executable instructions to perform the method for detection described above.

### BRIEF DESCRIPTION OF DRAWINGS

To describe the technical solutions according to embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other accompanying drawings from these accompanying drawings without creative efforts.

FIG. 1 is a schematic diagram of SL communication within a network coverage according to some exemplary embodiments of the present disclosure;

FIG. 2 is a schematic diagram of SL communication within a partial network coverage according to some exemplary embodiments of the present disclosure;

FIG. 3 is a schematic diagram of SL communication outside a network coverage according to some exemplary embodiments of the present disclosure;

FIG. 4 is a schematic diagram of a system architecture of a communication system according to some embodiments of the present disclosure;

FIG. 5 is a flowchart of a method for detection according to some exemplary embodiments of the present disclosure;

FIG. 6 is a flowchart of a method for measurement according to some exemplary embodiments of the present disclosure;

FIG. 7 is a flowchart of a method for evaluation according to some exemplary embodiments of the present disclosure;

FIG. 8 is a flowchart of a method for detection according to some exemplary embodiments of the present disclosure;

FIG. 9 is a flowchart of a method for detection according to some exemplary embodiments of the present disclosure;

FIG. 10 is a flowchart of a method for detection according to some exemplary embodiments of the present disclosure;

FIG. 11 is a flowchart of a method for detection according to some exemplary embodiments of the present disclosure;

FIG. 12 is a flowchart of a method for measurement according to some exemplary embodiments of the present disclosure;

FIG. 13 is a flowchart of a method for measurement according to some exemplary embodiments of the present disclosure;

FIG. 14 is a flowchart of a method for evaluation according to some exemplary embodiments of the present disclosure;

FIG. 15 is a schematic diagram of an evaluation time duration according to some exemplary embodiments of the present disclosure;

FIG. 16 is a block diagram of an apparatus for detection according to some exemplary embodiments of the present disclosure;

FIG. 17 is a block diagram of an apparatus for measurement according to some exemplary embodiments of the present disclosure;

FIG. 18 is a block diagram of an apparatus for evaluation according to some exemplary embodiments of the present disclosure; and

FIG. 19 is a schematic structural diagram of a communication device according to some exemplary embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. Reference may be made in detail to the embodiments, examples of which are illustrated in the accompanying drawings. When the following description refers to the accompanying drawings, the same numbers in different accompanying drawings represent the same or similar elements unless otherwise indicated. The embodiments described hereinafter do not represent all embodiments consistent with the present disclosure. Rather, these embodiments are merely examples of apparatus and methods consistent with some aspects of the present disclosure, as detailed in the appended claims.

The terms used in the present disclosure are for the purpose of describing particular embodiments only and are not intended to be limiting to the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” “third,” and the like may be used in the present disclosure to describe various information, such information should not be limited to these terms. These terms are only used to distinguish one type of information from another. For example, first information may be referred to as second information, and similarly, second information may be referred to as first information, without departing from the scope of the present disclosure. The word “if,” as used herein, may be interpreted as “in the case that,” “when,” or “in response to determining that,” depending on the context.

Some terms involved in the embodiments of the present disclosure are described as follows.

### SL Communication is Introduced.

SL communications (SL-based communication) are classified into the following three types based on a network coverage situation of terminals performing communication: an SL communication within a network coverage, an SL communication within a partial network coverage, and an SL communication outside a network coverage.

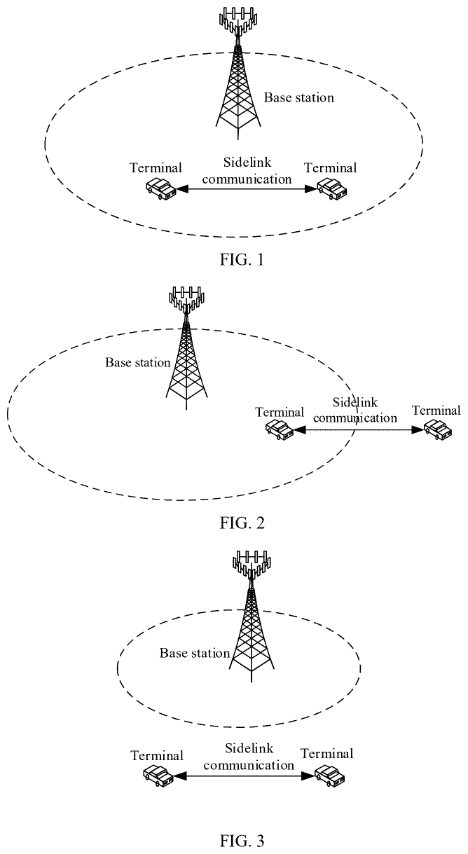

For example, FIG. 1 is a schematic diagram of an SL communication within a network coverage according to some embodiments of the present disclosure, FIG. 2 is a schematic diagram of an SL communication within a partial network coverage according to some embodiments of the present disclosure, and FIG. 3 is a schematic diagram of an SL communication outside a network coverage according to some embodiments of the present disclosure.

As illustrated in FIG. 1, during the SL communication within the network coverage, all terminals performing the SL communication are within a coverage of a same base station. In this way, the terminals are capable of performing the SL communication based on a same SL configuration by receiving configuration signaling from the base station. The SL configuration includes a time-frequency resource for the SL communication.

As illustrated in FIG. 2, during the SL communication within the partial network coverage, a first part of terminals performing the SL communication is within a coverage of a base station and is capable of receiving configuration signaling from the base station to perform the SL communication based on a configuration of the base station. A second part of the terminals performing the SL communication is outside the network coverage and is incapable of receiving the configuration signaling from the base station. In this case, the terminal outside the network coverage determines an SL configuration based on pre-configured information and information carried in a physical sidelink broadcast channel (PSBCH) transmitted by the terminal within the network coverage, to perform the SL communication.

As illustrated in FIG. 3, during the SL communication outside the network coverage, all terminals performing the SL communication are outside the network coverage. All terminals performing the SL communication determine an SL configuration based on pre-configured information to perform the SL communication.

### The Measurement Related to a New Radio (NR) SL is Introduced.

One of the features that distinguish an SL from a Uu-link is the synchronization process. A user (i.e., a terminal) uses the global navigation satellite system (GNSS), cells of NR or an evolved universal mobile telecommunications system (UMTS) terrestrial radio access network (EUTRAN/E-UTRAN), and other users that transmit SL synchronization signal blocks (S-SSBs) as synchronization sources (synchronization reference sources) thereof, and selects or reselects a synchronization source based on a predetermined or configured synchronization source priority order. The user triggers the transmission of an SL synchronization signal (SLSS) under a condition to expand the synchronization range, such that other users acquire synchronization information of the user. In some practices, corresponding measurement/evaluation metrics are defined.

### (1) Selection or Reselection of the Synchronization Source-Detection

Depending on the configuration, this is divided into two main categories:

1) The GNSS synchronization source is configured with the highest priority:
In the case where the user is directly synchronized to the GNSS (i.e., with the highest priority), there is no need to search for a synchronization source, and thus no need to drop a vehicle-to-everything (V2X) SLSS and data transmissions.
In Example 1, in the case where the user is synchronized to a synchronization reference terminal (SyncRef UE) (i.e., another user that serves as the synchronization source), and the synchronization reference terminal is directly or indirectly synchronized to the GNSS, the user only needs to search for the GNSS or another synchronization reference terminal synchronized (directly or indirectly) to the GNSS. In this case, the detection (detect) time duration is 1.6 s (an SLSS transmission period is fixed at 160 ms, 10 periods), and a maximum interruption proportion of the SLSS transmission of the user is 30%. That is, a maximum of 3 SLSSs are present within 10 periods. The specific description is as follows.

The terminal should not drop any V2X data transmission for the purpose of selection/reselection of the synchronization reference terminal. In the case where the synchronization reference terminal satisfies the defined selection/reselection criteria, the terminal should be able to identify a newly detected intra-frequency synchronization reference terminal within T_{detect,SyneRefUE_V2X} seconds. T_{detect,SyneRefUE_V2X} is defined as 1.6 seconds in the case where the specified Ês/Iot (representing a signal-to-noise ratio) for the S-SSB is ≥0 dB, provided that the terminal is allowed to drop a maximum of 30% of its SLSS transmissions during T_{detect,SyncRef UE_V2X}, in order to select/reselect the synchronization reference terminal.

In Example 1, the GNSS has the highest priority. In the case where the current synchronization reference terminal of the terminal is directly or indirectly synchronized to the GNSS, the terminal only needs to search for synchronization sources with higher or equal priorities. These synchronization sources are all directly or indirectly synchronized to the GNSS, and are approximately synchronized from the perspective of the terminal (typically with minor differences between arrival times, such as several μs). That is, Example 1 is a scenario of detecting synchronized synchronization sources. Therefore, it is only necessary to determine the position of the S-SSB based on the current timing for searching. This affects only the SLSS transmission of the terminal. However, the V2X data transmission is not affected.
In Example 2, in other cases (i.e., where the user is synchronized to a serving cell, or is indirectly synchronized to a cell), a synchronization source with a higher priority is asynchronous with the current synchronization source of the user, such that both V2X data and SLSS transmissions are affected. In this case, the detection (detect) time duration is 8 s (that is, 50 SLSS periods), and a maximum interruption proportion of the V2X data and SLSS transmissions of the user is 6%. That is, a maximum of 3 SLSSs are present within 50 periods. On this basis, reception dropping (Rx dropping) is further considered. For each physical SL broadcast channel (PSBCH) monitoring occasion, a maximum of 2 slots of V2X data reception is dropped, with a total drop proportion not exceeding 0.3% (where in the case where the timing of the V2X data currently received by the user is significantly different from that of a PSBCH of another synchronization source, simultaneous reception is not performed, and thus the V2X data needs to be dropped). In some practices, considering SL discontinuous reception (SL-DRX), some modifications have been made to reception dropping, allowing the user to extend the detection time duration under conditions. Details are as follows.

### Non-SL-DRX:

In the case where the synchronization reference terminal satisfies the defined selection/reselection criteria, the terminal should be able to identify a newly detected intra-frequency synchronization reference terminal within T_{detect,SyncRef UE_V2X} seconds. T_{detect,SyncRef UE_V2X} is defined as 8 seconds in the case where the specified Ês/Iot for the S-SSB is ≥0 dB, provided that the terminal is allowed to drop a maximum of 6% of its V2X data and SLSS transmissions during T_{detect,SyncRef UE_V2X}, in order to select/reselect the synchronization reference terminal.

The terminal is allowed to drop up to 2 slots of V2X data reception per PSBCH monitoring occasion. For selection/reselection of the synchronization reference terminal, the total dropping rate should not exceed 0.3% of its V2X data during T_{detect,SyncRef UE_V2X}, in order to select/reselect the synchronization reference terminal.

### SL-DRX:

In the case where the synchronization reference terminal satisfies the defined selection/reselection criteria, the terminal should be able to identify a newly detected intra-frequency synchronization reference terminal within T_{detect,SyncRef UE_V2X} seconds. T_{detect,SyncRef UE_V2X} is defined as 8 seconds in the case where the specified Ês/Iot for the S-SSB is ≥0 dB, provided that the V2X terminal is allowed to drop, to select/reselect the synchronization reference terminal, a maximum of 6% of its V2X data and SLSS transmissions, in order to select/reselect the synchronization reference terminal.

The terminal is allowed to drop up to 2 slots of V2X data reception per PSBCH monitoring occasion, and is allowed to drop an aggregated window of a maximum of 24 ms of its V2X data reception during T_{detect,SyncRef UE_V2X}, in order to select/reselect the synchronization reference terminal.

The terminal is allowed to extend T_{detect,SyncRefUE V2X} to max (4*50 SL-DRX cycle length, 8 s) in the case where a synchronization signal (SS)-reference signal receiving power (RSRP) is greater than a threshold syncTxThreshOoC within the following evaluation periods (evaluation time durations):
for NR cells used as synchronization reference sources, the evaluation period T_{evaluate,SLSS} in clause 12.3.1.1;
for EUTRA cells used as synchronization reference sources, the evaluation period T_{evaluate,SLSS} in clause 12.3.1.2; and
for SLSSs used as synchronization reference sources, exceeding the evaluation period T_{evaluate,SLSS} in clause 12.3.1.4. In the case where a plurality of SL-DRX cycles are configured, the SL-DRX cycle length is the longest one.

Example 2 is a scenario requiring the detection of asynchronous synchronization sources (both synchronous and asynchronous synchronization sources can be found).

2) In the case where the serving cell synchronization source is configured with the highest priority, the scenario is equivalent to Example 2 since the timings of different cells inherently have some deviation and are not completely synchronized.

### (2) Selection or Reselection of the Synchronization Source-PSBCH-RSRP Measurement

After detecting other (candidate) synchronization sources, the user needs to measure the PSBCH-RSRPs of these synchronization sources and determine, based on measurement results, whether to reselect the synchronization source, e.g., whether the RSRP of a synchronization source with a higher priority satisfies a condition, or that the RSRP of a synchronization source with the same priority is higher. Meanwhile, the user continuously measures the PSBCH-RSRP of the currently selected synchronization source to determine whether the current synchronization source is available. The measurement time duration is 2 max (S-SSB period, SL-DRX cycle), which is specifically as follows.

The terminal should be able to perform PSBCH-RSRP measurement on 3 identified intra-frequency synchronization reference terminals with a measurement period of T_{measure,PSBCH-RSRP} in Table 1. The above assumes that the intra-frequency synchronization reference terminal does not drop or delay any SLSS transmission within the measurement period. Otherwise, the measurement period is extended. Table 1 illustrates a PSBCH-RSRP measurement period of the intra-frequency synchronization reference terminal.

TABLE 1

| SL-DRX cycle [ms] | T_{measure, PSBCH-RSRP}[ms] |
|---|---|
| Non-SL-DRX | 320 |
| SL-DRX cycle ≤160 ms | 320 |
| SL-DRX cycle >160 ms | 2*SL-DRX cycle |

Note 1:
In the case where a plurality of SL-DRX cycles are configured, the SL-DRX cycle is the shortest one.

### (3) Initiation and Termination of SLSS Transmission-PSBCH-RSRP Evaluation

Whether the user transmits the SLSS needs to be determined based on the current synchronization source, which includes four cases, that is, the current synchronization source of the user is an NR cell, an EUTRAN cell, the GNSS, or another synchronization reference terminal. The embodiments of the present disclosure mainly discuss the last case.

In the case where the user is synchronized to another synchronization reference terminal, whether the user transmits the SLSS needs to be determined based on the currently measured PSBCH-RSRP of the synchronization source (synchronization reference terminal) of the user. For example, in the case where the PSBCH-RSRP is less than a configured threshold value, the user needs to transmit the SLSS. The evaluation time duration is 4 max (S-SSB period, SL-DRX cycle). The evaluation time duration includes 2 PSBCH-RSRP measurements, and the evaluation process allows higher-layer filtering for a plurality of PSBCH-RSRP measurement results.

The terminal should be able to measure the PSBCH-RSRP of the selected synchronization reference terminal used as the synchronization source and evaluate the same during T_{evaluate,SLSS} of the SLSS, so as to determine the initiation/termination of the SLSS transmission, as illustrated in Table 2. Table 2 illustrates T_{evaluate,SLSS} in the case where the synchronization reference terminal is used as the synchronization source.

TABLE 2

| SL-DRX cycle [ms] | T_{evaluate, SLSS}[ms] |
|---|---|
| Non-SL-DRX | 4*S-SSB period |
| SL-DRX cycle ≤160 ms | 4*S-SSB period |
| SL-DRX cycle >160 ms | 4*SL-DRX cycle |

Note 1:
In the case where a plurality of SL-DRX cycles are configured for the SL terminal, the required SL-DRX cycle is the shortest one. This requirement does not apply during a transition in the case where the shortest SL-DRX cycle used by the terminal changes.

In the case where the higher-layer filtering for the PSBCH-RSRP measurement is pre-configured, additional delays occur in the evaluation of initiation/termination of the SLSS transmission.

An SL-U is introduced.

In some practices, the SL communication is enhanced by extending to an unlicensed spectrum, i.e., the SL-U. In the unlicensed spectrum, it is necessary to first determine whether a channel is idle using a carrier channel listening mechanism such as listen before talk (LBT), and signals are transmitted only after the channel is idle, such that the SLSS is not transmitted normally in some cases, which consequently affects the measurement time duration (including time durations for synchronization source detection, PSBCH-RSRP measurement, evaluation, or the like) corresponding to a receiver.

In the intra-frequency measurement of the NR-U, Lpss/sss sampling points are added to the original measurement time duration. Lpss/sss represents the number of unavailable SSB measurement timing configurations (SMTCs). For example, in the case where 5 sampling points were originally required for measurement, but the receiver finds that an SMTC for one of the sampling points is unavailable, the measurement is extended by one period, and Lpss/sss=1. A maximum value of Lpss/sss, i.e., Lpss/sss_max, is constrained in the protocol to avoid infinite extension of the measurement time duration. In the case where the number of unavailable SMTCs exceeds the maximum value, the terminal does not need to satisfy requirements for primary synchronization signal (PSS) and secondary synchronization signal (SSS) detection. Table 3 illustrates the period for PSS/SSS detection (frequency range 1 (FR1)).

TABLE 3

| Case | T_{PSS/SSS}_{_{—}}_{sync}_{_{—}}ᵢₙₜᵣₐ_{_{—}}_{CCA} |
|---|---|
| Non-DRX | max(600 ms, ceil((5 + L_{PSS/SSS})*Kₚ)*SMTC |
| | period)*CSSFᵢₙₜᵣₐ |
| DRX cycle ≤320 ms | Max(600 ms, |
| | ceil(1.5*(5 + L_{PSS/SSS})*Kₚ)*max(SMTC period, |
| | DRX cycle))*CSSFᵢₙₜᵣₐ |
| DRX cycle >320 ms | Ceil((5 + L_{PSS/SSS})*Kₚ)*DRX cycle*CSSFᵢₙₜᵣₐ |

Note 1:
In the case where different SMTC periods are configured for different cells, the required SMTC period is used by the identified cell.
Note 2:
In the case where DRX is not configured, L_{PSS/SSS} represents the number of SMTC occasions during T_{PSS/SSS}_{_{—}}_{sync}_{_{—}}ᵢₙₜᵣₐ_{_{—}}_{CCA} where the terminal is unavailable for PSS/SSS detection, where L_{PSS/SSS} < L_{PSS/SSS, max}. In the case where DRX is configured, L_{PSS/SSS} represents the number of DRX cycles during T_{PSS/SSS}_{_{—}}_{sync}_{_{—}}ᵢₙₜᵣₐ_{_{—}}_{CCA} for PSS/SSS detection where the terminal has at least one SMTC occasion unavailable, where L_{PSS/SSS} < L_{PSS/SSS, max}. In the case where DRX is configured, the terminal does not need to determine the availability of SMTC occasions more frequently than once per DRX cycle. The terminal does not need to determine the availability of SMTC occasions more frequently than required by CSSFᵢₙₜᵣₐ.
Note 3:
L_{PSS/SSS, max} = 7 in the case where Max(DRX cycle, SMTC period) ≤ 40 ms (where the non-DRX DRX cycle is 0); L_{PSS/SSS, max} = 5 in the case where 40 ms < Max(DRX cycle, SMTC period) ≤ 320 ms; and L_{PSS/SSS, max} = 3 in the case where DRX cycle > 320 ms.
Note 4:
In the case where L_{PSS/SSS, max} is exceeded, the terminal does not need to satisfy the requirements for PSS/SSS detection.
Kₚ and CSSFᵢₙₜᵣₐ represent carrier-level scaling factors.

For the SL-U, how to extend the above measurement time duration is a problem that needs to be resolved. Some candidate solutions are provided in some practices, which are specifically as follows.

### For Selection/Reselection of a V2X Synchronization Source:

Requirements for the synchronization reference terminal directly or indirectly synchronized to the GNSS:

In the case where the synchronization reference terminal satisfies the defined selection/reselection criteria, the terminal should be able to identify a newly detected intra-frequency synchronization reference terminal within T_{detect,SyncRef UE_V2X} seconds. T_{detect,SyncRef UE_V2X} is defined as (A) in the case where the specified Ês/Iot for the S-SSB is ≥0 dB, provided that the terminal is allowed to drop a maximum value (B) for the purpose of selection/reselection of the synchronization reference terminal. A represents the time duration required for detection, and B represents a dropping probability. This targets the synchronous scenario, i.e., Example 1.

### Option 1:

$$\cdot A \text{:} ( 1.6 + 1.6 * x 1 ) seconds ;$$

B: 30% of SLSS transmissions during T_{detect,SyncRef UE_V2X}.
The value of x1 is the number of 1.6 s detection windows where at least one S-SSB period is unavailable in the three selected S-SSB periods for S-SSB search. The selection of the three S-SSB periods in the 1.6 s detection window depends on terminal implementations. x1<x1_max.

### Option 2:

$$\cdot A \text{:} ( 1.6 + 0.16 * x 1 ) seconds ;$$

$$\cdot B - 1 \text{:} [ ( 3 + x 1 \_max ) / ( 10 + x 1 \_max ) ] * 100 \text{} \% of SLSS transmissions during {T}_{detect , SyncRef UE \_ V 2 X} ;$$

$$and$$

$$\cdot B - 2 \text{:} [ ( 3 + x 1 ) / ( 10 + x 1 ) ] * 100 \% of SLSS transmissions during {T}_{detect , SyncRef UE \_ V 2 X} .$$

x1 represents the number of unavailable S-SSB periods. x1<x1_max.

In the case where the synchronization reference terminal satisfies the defined selection/reselection criteria, the terminal should be able to identify a newly detected intra-frequency synchronization reference terminal within T_{detect,SyncRef UE_V2X} seconds. T_{detect,SyncRef UE_V2X} is defined as (C) in the case where the specified Ês/Iot for the S-SSB is ≥0 dB, provided that the terminal is allowed to drop a maximum value (D) for the purpose of selection/reselection of the synchronization reference terminal. C represents the time duration required for detection, and D represents a dropping probability. This targets the asynchronous scenario, i.e., Example 2.

### Option 1:

$$\cdot C \text{:} ( 8 + 8 * x 2 ) seconds ;$$

D: 6% of V2X data and SLSS transmissions during T_{detect,SyncRef UE_V2X}.
The value of x2 is the number of 8 s detection windows where at least one S-SSB period is unavailable in the 480 ms search window of each 8 s period. The position of the 480 ms search window depends on terminal implementations. x2<x2_max.

### Option 2:

$$\cdot C \text{:} ( 8 + 0.16 * x 2 ) seconds ;$$

$$\cdot D - 1 \text{:} [ ( 0.48 + 0.16 * x 2 \_max ) / ( 8 + 0.16 * x 2 \_max ) ] * 100 \% of V 2 X data and SLSS transmissions during {T}_{detect , SyncRef UE \_ V 2 X} ;$$

$$and$$

$$\cdot D - 2 \text{:} [ ( 0.48 + 0.16 * x 2 ) / ( 8 + 0.16 * x 2 ) ] * 100 \% of V \text{} \text{} 2 \text{} X data and SLSS transmissions during {T}_{detect , SyncRef UE \_ V 2 X} .$$

x2 represents the number of unavailable S-SSB periods. x2<x2_max.

The reception dropping rate of V2X data reception during T_{detect,SyncRef UE_V2X} is used for selecting/reselecting the synchronization reference terminal.

### Requirements for T_{measure,PSBCH-RSRP}:

Regarding the information of “y” and “y_max” values, the protocol for the requirements for T_{measure,PSBCH-RSRP} in some practices is illustrated in Table 4:

TABLE 4

| SL-DRX cycle [ms] | T_{measure, PSBCH-RSRP}[ms] |
|---|---|
| Non-SL-DRX | (2 + y)*160 |
| SL-DRX cycle ≤160 ms | (2 + y)*160 |
| SL-DRX cycle >160 ms | (2 + y)*SL-DRX cycle |

y represents a number of S-SSB periods where an SLSS is unavailable due to an LBT failure, and y_max has an upper limit.
In option 1, much progress is required to determine the value of y in T_{measure,PSBCH-RSRP}.
In option 2, the number of S-SSB occasions within the S-SSB period should be considered to define L_{PSBCH,max} (y_max) for initiating/terminating SLSS transmission requirements, and L_{PSBCH,max} uses the value of L_{SLSS,max}.
In option 3, y is the number of S-SSB occasions unavailable for the terminal during T_{evaluate,SLSS,SL-U} for S-SSB evaluation, where y≤y_max.
In option 4, T_{measure,PSBCH-RSRP} is considered to be extended by y, with y_max as the upper limit. The terminal considers y and y_max based on the priority of the synchronization source, or other solutions are considered.
In option 5, in reselection requirements for the synchronization reference terminal, for all DRX cycles, a maximum allowable number of LBT failures during the measurement time duration T_{measure,PSBCH-RSRP} is defined as 16.
   Requirements for the Case where the Maximum Allowable Number of LBT Failures is Exceeded:
In option 1, in the case where the maximum allowable number of LBT failures for selection/reselection of the V2X synchronization source is exceeded, no additional requirement or procedure is defined.
In option 2, in the case where the maximum allowable number of LBT failures is exceeded during T_{measure,PSBCH-RSRP}, the terminal should stop using the synchronization reference terminal as the synchronization reference source.

In the case where the PSBCH-RSRP measurement exceeds the maximum allowable number of LBT failures, the behavior of the user needs to be clarified.

### Requirements for the Synchronization Reference Terminal as the Synchronization Reference Source:

Regarding the information of “x” and “x_max” values, the protocol for initiating/terminating SLSS transmission requirements in some practices is as follows.

The measurement (evaluation) period is extended to (4+x) S-SSB periods, where x is a number of S-SSB periods where an SLSS is unavailable due to an LBT failure, with x_max as the upper limit.
In option 1, much progress is required to determine the value of x_max in the measurement period requirement.
In option 2, the number of S-SSB occasions within the S-SSB period should be considered to define L_{SLSS,max} (x_max) for initiating/terminating SLSS transmission requirements.
In option 3, x_max=[4] is introduced in some practices for the requirement regarding the synchronization reference terminal as the synchronization reference source.
In option 4, x represents the number of S-SSB occasions unavailable for the terminal during T_{evaluate,SLSS,SL-U} for S-SSB evaluation, where x≤x_max; and x_max=5 in the case of non-SL-DRX or SL-DRX cycle≤160 ms, and x_max=3 in the case of SL-DRX cycle>160 ms.
In option 5, it is considered in some practices to extend the evaluation period T_{evaluate,SLSS} by x S-SSB periods or SL-DRX cycles, where x and x_max are determined, for example, based on a priority of the synchronization source or other criteria for associating the values of x and x_max; and it should be further considered in some practices to extend the measurement period requirement on the basis of S-SSB design considerations.
In option 6, for all DRX cycles, the maximum allowable number of LBT failures (X_max) during the evaluation of initiation/stopping of the SLSS is defined as 32.

In the case where the synchronization reference terminal is used as the synchronization source, the user is evaluating the time duration required for the initiation/termination of the SLSS.

Based on the above description, it is currently necessary to clarify how to determine a synchronization-related detection/measurement/evaluation time duration in the SL-U and a terminal behavior in the case where a set maximum value is exceeded. Specifically, this may be divided into the following problems.

(1) It is necessary to clarify how to determine a time duration for detecting the synchronization reference terminal in the SL-U and an allowable transmission/reception dropping rate (Tx/Rx dropping rate) in the process of detecting other synchronization sources.

(2) It is necessary to clarify how to determine a PSBCH-RSRP measurement time duration in the SL-U and a behavior of the receiver in the case where the required measurement time duration exceeds the maximum allowable value. Current solutions suggest re-measurement, but infinitely re-measurement of the same synchronization source wastes resources of the receiver and miss new synchronization sources.

(3) It is necessary to clarify how to determine a PSBCH-RSRP evaluation time duration in the SL-U and a behavior of the receiver in the case where the required evaluation time duration exceeds the maximum allowable value, especially regarding whether to trigger SLSS transmission.

The method according to the embodiments of the present disclosure provides determination modes for time durations and terminal behaviors for three radio resource management (RRM) related procedures in the SL-U, which include:

(1) A detection time duration of the synchronization reference terminal is determined.

a. The detection time duration is gradually increased based on the detection result (sampling result), and the termination condition is optimized. Compared to other existing solutions, the detection time duration is prioritized reducing.

b. A maximum detection time duration (which is independent of the detection result) is directly used, and the number of selectable detection time durations within the detection time duration is correspondingly increased.

(2) For the PSBCH-RSRP measurement time duration, in the case where the required measurement time duration exceeds the maximum allowable time duration, the receiver needs to re-measure the synchronization reference terminal. In this case, it is necessary to distinguish whether the synchronization reference terminal is lost or fails to transmit the SLSS due to the LBT failure, so as to determine whether the receiver terminates the measurement or continues re-measurement. In the case of terminating the measurement, it is necessary to further distinguish whether the synchronization reference terminal has been selected as the synchronization source or is a candidate synchronization source, and provide the behavior of the receiver for each case.

### (3) for the PSBCH-RSRP Evaluation Time Duration:

a. An extension parameter of the evaluation time duration x_max=2*y_max (for extending the measurement time duration).

b. In the case where the required evaluation time duration exceeds the maximum allowable time duration, it is also necessary to distinguish whether the synchronization reference terminal loses the SLSS or fails to transmit the SLSS due to the LBT failure, so as to determine whether the receiver determines to transmit the SLSS. For the latter case, whether to transmit the SLSS is further determined based on a previous behavior, capability, network configuration, synchronization source, or the like of the receiver.

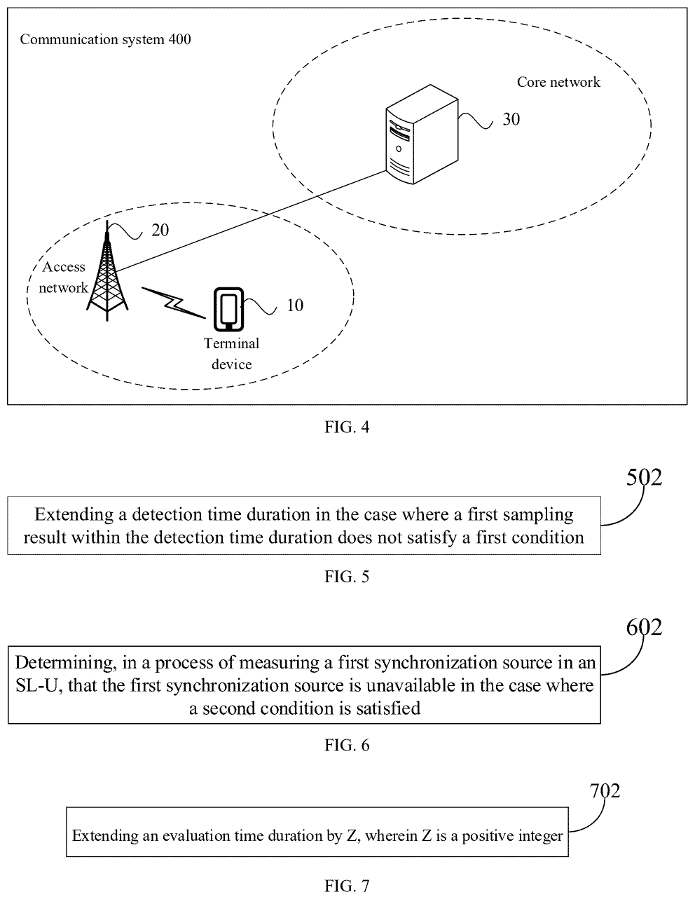

FIG. 4 illustrates a schematic diagram of a system architecture of a communication system 400 according to some embodiments of the present disclosure. The system architecture includes a terminal 10, an access network device 20, and a core network device 30.

The terminal 10 may refer to a user equipment (UE), an access terminal, a subscriber unit, a subscriber station, a mobile station, a mobile terminal, a remote station, a remote terminal, a mobile device, a wireless communication device, a user agent, or a user apparatus. In some embodiments, the terminal is also a cellular phone, a cordless phone, a session initiation protocol (SIP) phone, a wireless local loop (WLL) station, personal digital assistant (PDA), a handheld device with wireless communication function, a computing device, or another processing device connected to a wireless modem, a vehicle-mounted device, a wearable device, a terminal in a 5th generation system (5GS), or a terminal in a public land mobile network (PLMN) evolved in the future, or the like, which is not limited in the embodiments of the present disclosure. For convenience of description, the devices described above are collectively referred to as terminals.

It should be noted that a plurality of terminals 10 are usually deployed, and one or more terminals 10 may be distributed in a cell managed by each access network device 20. In addition, one or more terminals 10 may also be distributed outside the cell managed by the access network device 20. Different terminals 10 may communicate with each other based on an SL.

The access network device 20 is a device deployed in an access network to provide a wireless communication function for the terminal 10. The access network device 20 may include various forms of macro base stations, micro base stations, relay stations, access points, or the like. In systems using different radio access technologies, a device with the functionality of an access network device may have different names. For example, the device is referred to as gNodeB or gNB in the 5G NR system. As communication technologies evolve, the name “access network device” may change. For convenience of description, in the embodiments of the present disclosure, the above apparatuses for providing the terminals 10 with the wireless communication function are collectively referred to as access network devices. In some embodiments, a communication relationship is established between the terminal 10 and the core network device 30 through the access network device 20. Exemplarily, in a long-term evolution (LTE) system, the access network device 20 is an evolved universal terrestrial radio access network (EUTRAN) or one or more eNodeBs in EUTRAN; and in a 5G NR system, the access network device 20 is a radio access network (RAN) or one or more gNBs in the RAN.

The core network device 30 mainly functions to provide user connections, user management, and service bearing, and serves as a bearer network to provide an interface to an external network. For example, the core network device in the 5G NR system includes an access and mobility management function (AMF) entity, a user plane function (UPF) entity, a session management function (SMF) entity, or the like. The access network device 20 and the core network device 30 are collectively referred to as network devices.

In some embodiments, the access network device 20 and the core network device 30 communicate with each other over an air technology, such as an NG interface in the 5G NR system. The access network device 20 and the terminal 10 communicate with each other over an air technology, such as a Uu interface. The terminal 10 and the terminal 10 communicate with each other over an air technology, such as a PC5 interface.

FIG. 5 is a flowchart of a method for detection according to some exemplary embodiments of the present disclosure. The method is performed by an SL terminal. The method includes the following process.

In S502, a detection time duration is extended in the case where a first sampling result within the detection time duration does not satisfy a first condition.

The SL terminal is a terminal that supports SL communication. In some embodiments, the SL terminal is a V2X terminal.

The detection time duration is used for the SL terminal to detect a synchronization source via an SL-U. It should be noted that, in the embodiments of the present disclosure, detection is equivalent to/replaceable with discovery/probing.

In some embodiments, the types of objects that may be used as the synchronization source include at least one of the GNSS, a cell, or a synchronization reference terminal. The synchronization reference terminal is directly or indirectly synchronized to the GNSS or the cell. In some embodiments, the cell includes at least one of an NR cell or an EUTRAN cell. Each type of synchronization source corresponds to a synchronization source priority. In some embodiments, the synchronization source priority of the GNSS is higher than that of the cell, that is, the synchronization source with the highest synchronization source priority is the GNSS. In some embodiments, the synchronization source priority of the cell is higher than that of the GNSS. In some embodiments, for the synchronization source priority of the synchronization reference terminal, reference may be made to the synchronization source priority of its current synchronization source, but its priority is lower than that of its current synchronization source.

In some embodiments, the current synchronization source of the SL terminal is the synchronization reference terminal, and a synchronization source to which the synchronization reference terminal is directly or indirectly synchronized is synchronized to the synchronization source with the highest synchronization source priority. In this case, the scenario is referred to as a synchronous scenario. For example, the current synchronization source of the SL terminal is the synchronization reference terminal that is directly or indirectly synchronized to the GNSS.

In some embodiments, the current synchronization source of the SL terminal is the synchronization reference terminal, and a synchronization source to which the synchronization reference terminal is directly or indirectly synchronized has a timing different from that of the synchronization source with the highest synchronization source priority. In this case, the scenario is referred to as an asynchronous scenario. For example, the current synchronization source of the SL terminal is directly or indirectly synchronized to the cell. The type of the current synchronization source of the SL terminal affects the detection time duration, as described hereinafter.

In some embodiments, the detection time duration includes one or more basic detection time durations. In some embodiments, the basic detection time duration includes at least one of:
one or more SLSS periods;
one or more S-SSB periods; or
one or more SL-DRX cycles.

In some embodiments, the basic detection time duration includes a plurality of SLSS periods. In some embodiments, the basic detection time duration includes a plurality of S-SSB periods. In some embodiments, the basic detection time duration includes a plurality of SL-DRX cycles.

It should be noted that, in the embodiments of the present disclosure, the detection time duration is equivalent to/replaceable with a detection duration, and the basic detection time duration is equivalent to/replaceable with a basic detection duration, a detection time duration cell, or a detection time duration unit. This is not limited in the embodiments of the present disclosure. It should be noted that, in the embodiments of the present disclosure, the S-SSB is equivalent to/replaceable with the SLSS.

In some embodiments, in the case where the detection time duration is not extended, the detection time duration includes one or more basic detection time durations, for example, includes only one basic detection time duration. The basic detection time duration is used for extending the detection time duration, for example, extending the detection time duration in a unit of the basic detection time duration. It can be understood that the basic detection time duration is a fundamental unit for extending the detection time duration. For the process of extending the detection time duration, reference may be made to the following descriptions.

In some embodiments, each basic detection time duration includes one or more detection periods. The detection period includes at least one of an SLSS period, an S-SSB period, or an SL-DRX cycle. In some embodiments, the first sampling result includes a sampling result for a synchronization signal. The synchronization signal is transmitted by the synchronization source and is used for detecting the synchronization source. In some embodiments, the sampling result is equivalent to/replaceable with the detection result. The synchronization signal includes at least one of:
an SLSS; or
an S-SSB.

In some embodiments, in the case where the current synchronization source of the SL terminal is the synchronization reference terminal, and the synchronization reference terminal is directly or indirectly synchronized to the synchronization source with the highest synchronization source priority (for example, the GNSS is configured with the highest priority, and the synchronization reference terminal is directly or indirectly synchronized to the GNSS), the basic detection time duration includes 10 SLSS periods, for example, 10*160 ms, i.e., 1.6 s.

In some embodiments, in the case where the current synchronization source of the SL terminal is the synchronization reference terminal, and a synchronization source to which the synchronization reference terminal is directly or indirectly synchronized has a timing different from that of the synchronization source with the highest synchronization source priority (for example, the GNSS is configured with the highest priority, and the synchronization reference terminal is directly or indirectly synchronized to the cell; or the cell is configured with the highest priority, and the synchronization reference terminal is synchronized to the cell or the GNSS), the basic detection time duration includes 50 SLSS periods, for example, 50*160 ms, i.e., 8 s.

For the case where the detection time duration is gradually extended based on the sampling result:

In some embodiments, the detection time duration includes a plurality of basic detection time durations. In some embodiments, in the case where the un-extended detection time duration includes one basic detection time duration, the case where the detection time duration includes the plurality of basic detection time durations is acquired by extending the un-extended detection time duration. In this case, the detection time duration including the plurality of basic detection time durations is an extended detection time duration. For example, the detection time duration includes two basic detection time durations. One of the two basic detection time durations is a basic detection time duration in the detection time duration without extension, and the other basic detection time duration is used for extending the detection time duration. In some embodiments, the detection time duration includes one basic detection time duration. In this case, the detection time duration is not extended. The extension of the detection time duration is performed with reference to the following solution.

The first sampling result is determined based on second sampling results within one or more (or each) of the plurality of basic detection time durations. In this solution, the SL terminal combines the second sampling results within different basic detection time durations to determine whether the detection time duration needs to be extended. However, in the solution mentioned in the Background, in determining whether to extend the detection time duration, only the sampling result within the latest extended basic detection time duration is considered, but the sampling results within previous basic detection time durations are completely dropped. The above solution according to the embodiments of the present disclosure may reduce the detection time duration used by the SL terminal, thereby reducing terminal overheads.

In some embodiments, in the case where the first sampling result within the detection time duration does not satisfy the first condition, the SL terminal extends the detection time duration by m basic detection time durations. m is a positive integer. In some embodiments, m equals 1. That is, for each extension of the detection time duration, the detection time duration is extended by only one basic detection time duration. It should be noted that the number of basic detection time durations used for each extension of the detection time duration is the same or different.

In some embodiments, in the case where the first sampling result within the detection time duration satisfies the first condition, the SL terminal stops extending the detection time duration and determines that the synchronization source is detected.

In some embodiments, the first sampling result includes the sampling result for the synchronization signal. Each basic detection time duration is used for sampling the synchronization signal for n times. n is a positive integer. In some embodiments, n equals 3. In some embodiments, in synchronization signal sampling within the basic detection time duration, the SL terminal randomly selects n detection periods to perform sampling for n times. It should be noted that although the SL terminal intends to perform sampling for n times, an actual sampling number is affected by the actual situation of the synchronization source, resulting in the actual sampling number in the basic detection time duration failing to reach n.

In some embodiments, the above synchronization signal includes at least one of the SLSS or the S-SSB.

In some embodiments, the first condition includes at least one of:
a cumulative sampling number for the synchronization signal within the detection time duration is greater than or equal to K, wherein K is a positive integer; or
a time interval between two consecutive synchronization signal samplings does not exceed P, where P is a positive integer.

In some embodiments, the two consecutive synchronization signal samplings refer to any two consecutive synchronization signal samplings in a plurality of synchronization signal samplings that satisfy the cumulative sampling number.

In some embodiments, a manner of determining K includes at least one of:
K being predetermined;
K being determined based on a terminal capability; or
K being configured by a network device.

In some embodiments, a manner of determining P includes at least one of:
P being predetermined;
P being determined based on a terminal capability; or
P being configured by a network device.

In some embodiments, a number of extensions corresponding to the detection time duration is less than N (N is a positive integer), that is, the number of extensions of the detection time duration should not exceed a limit of N. The number of extensions is a cumulative number of times that the detection time duration has been extended by the basic detection time duration. The number of extensions is equivalent to/replaceable with a number of extensions, and the number of extensions is a cumulative number of times that the detection time duration has been extended by the basic detection time duration.

In some embodiments, in the case where the number of extensions is greater than N, the SL terminal determines that the synchronization source is not detected.

In some embodiments, N is related to an SL-DRX configuration. In some embodiments, in the case of non-SL-DRX or in a case where an SL-DRX cycle is less than a first value, N is a first numerical value. In some embodiments, in the case where the SL-DRX cycle is greater than the first value, N is a second numerical value. In some embodiments, the first numerical value is different from the second numerical value. For example, the first numerical value is greater than the second numerical value.

In some embodiments, N is related to the synchronization source priority of the current synchronization source of the SL terminal. In some embodiments, in the case where the current synchronization source of the SL terminal is the synchronization reference terminal, and a synchronization source to which the synchronization reference terminal is directly or indirectly synchronized is synchronized to the synchronization source with the highest synchronization source priority, N is the first numerical value. In some embodiments, in the case where the current synchronization source of the SL terminal is the synchronization reference terminal, and a synchronization source to which the synchronization reference terminal is directly or indirectly synchronized has a timing different from that of the synchronization source with the highest synchronization source priority, N is a third numerical value. In some embodiments, the third numerical value is different from the first numerical value and the second numerical value. For example, the third numerical value is greater than the first numerical value.

It should be noted that N, K, and P in the synchronous scenario and the asynchronous scenario are completely the same, partially the same, or completely different. Exemplarily, for the above synchronous scenario, the detection time duration is represented as T_{detect}=(1.6+1.6*x1). x1 represents the number of extensions in the synchronous scenario, x1<x1_max, and x1_max is N in the synchronous scenario. For the above asynchronous scenario, T_{detect}=(8+8*x2). x2 is the number of extensions in the asynchronous scenario, x2<x2_max, and x2 max is N in the asynchronous scenario.

### For the Case of Directly Extending to a Maximum Detection Time Duration:

In some embodiments, in the case where the first sampling result within the detection time duration does not satisfy the first condition, the SL terminal extends the detection time duration by N basic detection time durations, wherein N is a positive integer. The extended detection time duration includes (N+1) basic detection time durations. In some embodiments, the detection time duration before extension includes only one basic detection time duration.

In some embodiments, the first sampling result includes the sampling result for the synchronization signal. Each basic detection time duration includes one or more detection periods. In some embodiments, the detection period includes at least one of an SLSS period, an S-SSB period, or an SL-DRX cycle. The SL terminal selects (1+N)*n detection periods from (N+1) basic detection time durations for performing synchronization signal sampling. n is a positive integer. In some embodiments, the numbers of detection periods selected by the SL terminal from different basic detection time durations are the same or different. In some embodiments, n equals 3. In some embodiments, the SL terminal randomly selects the (1+N)*n detection periods from the detection time duration. In some embodiments, the synchronization signal includes at least one of the SLSS or the S-SSB.

In some embodiments, in the case where sampling results within the (N+1) basic detection time durations do not satisfy the first condition, the SL terminal determines that the synchronization source is not detected.

In some embodiments, the first condition includes at least one of:
a cumulative sampling number for the synchronization signal within the detection time duration is greater than or equal to K; or
a time interval between two consecutive synchronization signal samplings does not exceed P, where P is a positive integer.

In the above solution, in sampling the synchronization signal, the numbers of detection periods selected by the SL terminal from different basic detection time durations are different. In addition, the SL terminal further combines the sampling results within different basic detection time durations to determine, based on the first condition, whether the synchronization source is detected. However, in the solution mentioned in the Background, in sampling the synchronization signal, the numbers of detection periods selected from different basic detection time durations are the same, and only the sampling result within a basic detection time duration is considered. The above solution according to the embodiments of the present disclosure may improve the flexibility of sampling the synchronization signal, thereby improving the possibility of detecting the synchronization source.

In some embodiments, N is related to an SL-DRX configuration. In some embodiments, in the case of non-SL-DRX or in a case where an SL-DRX cycle is less than a first value, N is a first numerical value. In some embodiments, in the case where the SL-DRX cycle is greater than the first value, N is a second numerical value. In some embodiments, N is related to the synchronization source priority of the current synchronization source of the terminal.

In some embodiments, a manner of determining K includes at least one of:
K being predetermined;
K being determined based on a terminal capability; or
K being configured by a network device.

In some embodiments, a manner of determining P includes at least one of:
P being predetermined;
P being determined based on a terminal capability; or
P being configured by a network device.

It should be noted that N, K, and P in the above two cases of gradually extending the detection time duration based on the sampling result and directly extending the detection time duration to the maximum detection time duration are completely the same, partially the same, or completely different. Exemplarily, for the above synchronous scenario, the maximum detection time duration is represented as T_{detect}=(1.6+1.6*x1_max). x1_max represents N in the synchronous scenario. For the above asynchronous scenario, T_{detect}=(8+8*x2_max). x2_max represents N in the asynchronous scenario.

In some embodiments, a third condition is used for the SL terminal to determine whether to extend the detection time duration. The third condition includes at least one of:
the cumulative sampling number for the synchronization signal within the detection time duration is less than K; or
the time interval between two consecutive synchronization signal samplings exceeds P.

In some embodiments, in the case where the first sampling result within the detection time duration satisfies the third condition, the SL terminal extends the detection time duration. For implementations of extending the detection time duration and implementations of constraining the extension of the detection time duration by N, reference may be made to the related descriptions above for the synchronous scenario and the asynchronous scenario, which are not repeated herein in the embodiments of the present disclosure. In some embodiments, in the above synchronous scenario, in the case where the first sampling result within the detection time duration does not satisfy the third condition, the SL terminal stops extending the detection time duration and determines that the synchronization source is detected. For related values in the third condition, reference may be made to the foregoing descriptions, which are not repeated herein in the embodiments of the present disclosure.

In summary, the method according to the embodiments clarifies the manner of determining the detection time duration in the SL-U by clarifying the mode for extending the detection time duration in detecting the synchronization source in the SL-U, and thus provides the implementation of detecting the synchronization source in the SL-U.

FIG. 6 is a flowchart of a method for measurement according to some exemplary embodiments of the present disclosure. The method is performed by an SL terminal. The method includes the following process.

In S602, it is determined, in a process of measuring a first synchronization source in an SL-U, that the first synchronization source is unavailable in the case where a second condition is satisfied.

In some embodiments, the second condition includes at least one of:
no measurement result being measured within Q consecutive maximum measurement time durations, wherein Q is a positive integer, and the maximum measurement time duration is acquired by extending a measurement time duration by X, wherein X is a positive integer;
no measurement result being measured within Y consecutive measurement periods, where each measurement time duration includes a plurality of measurement periods, and Y is a positive integer; or
no measurement result being measured within a first duration.

In some embodiments, the maximum measurement time duration includes a plurality of measurement periods. In some embodiments, the measurement period includes at least one of an SLSS period, an S-SSB period, or an SL-DRX cycle. In some embodiments, in the case where the SL terminal measures no measurement result within an un-extended measurement time duration, the SL terminal extends the measurement time duration in a unit of the measurement period and continues the measurement. Then, in the case where the measurement time duration is extended to the maximum measurement time duration but no measurement result is measured, the SL terminal performs the measurement again in the above manner. In some embodiments, the above second condition is used for determining whether to stop measuring the first synchronization source.

In some embodiments, no measurement result being measured refers to not measuring a sufficient number of measurement results, that is, an actual number of measurements does not satisfy a requirement. Measurement results being measured alternatively refers to measuring the sufficient number of measurement results, that is, the actual number of measurements satisfies the requirement.

In some embodiments, the maximum measurement time duration is acquired by extending the measurement time duration by a maximum number of measurement periods. In some embodiments, measuring the first synchronization source refers to measuring a PSBCH-RSRP of the first synchronization source.

In some embodiments, the maximum measurement time duration is represented as (2+y_max)*160 or (2+y_max)*SL-DRX cycle. 160 refers to the SLSS period, and y_max represents a maximum number of extensions, that is, a maximum number of measurement periods extended on the basis of two measurement periods (measurement time duration without extension). The maximum number of extensions is equivalent to/replaceable with a maximum number of extensions, that is, a maximum number of extended measurement periods (extending by one measurement period each time) on the basis of two measurement periods (measurement time duration without extension). In some embodiments, y_max=2.

In some embodiments, a manner of determining Q (Q is a positive integer) includes at least one of:
Q being predetermined;
Q being determined based on a terminal capability;
Q being configured by a network device;
Q being determined based on a synchronization source priority or a type of the first synchronization source; or
Q being determined based on a synchronization source priority or a type of the synchronization source currently selected by the terminal.

In some embodiments, a manner of determining Y includes at least one of:
Y being predetermined;
Y being determined based on a terminal capability;
Y being configured by a network device;
Y being determined based on a synchronization source priority or a type of the first synchronization source; or
Y being determined based on a synchronization source priority or a type of the synchronization source currently selected by the terminal.

In some embodiments, a manner of determining the first duration includes at least one of:
the first duration being predetermined;
the first duration being determined based on a terminal capability;
the first duration being configured by a network device;
the first duration being determined based on a synchronization source priority or a type of the first synchronization source; or
the first duration being determined based on a synchronization source priority or a type of the synchronization source currently selected by the terminal.

It should be noted that, in the embodiments of the present disclosure, the determination modes for Q, Y, and the first duration are completely the same, partially the same, or completely different.

In some embodiments, the first synchronization source is the synchronization reference terminal. In some practices, in the case where the SL terminal measures the first synchronization source, an extension parameter of the measurement time duration exceeds a maximum extension parameter due to an LBT failure/the synchronization reference terminal being no longer located in the current region (invisible). In this case, the SL terminal in some practices endlessly re-measures the first synchronization source, resulting in high overheads of the SL terminal. The method according to the embodiments of the present disclosure introduces the second condition to stop the measurement of the synchronization source to avoid endless repeated measurements of the same synchronization source, and provides the behavior of the SL terminal in the case where the second condition is satisfied. The content is as follows.

For a case where the first synchronization source being unavailable:

In some embodiments, in the case where the first synchronization source is unavailable (the second condition being satisfied is considered as the first synchronization source being no longer located in the current region (invisible), rather than the LBT failure), the SL terminal stops measuring the first synchronization source.

In some embodiments, in the case where the first synchronization source is the synchronization source currently selected by the SL terminal, the SL terminal triggers synchronization source detection.

In some embodiments, in the case where the first synchronization source is the synchronization source currently selected by the SL terminal, the status of the SL terminal changes from having the first synchronization source (synchronization reference terminal) as the synchronization source to having no synchronization source.

In some embodiments, in the case where the first synchronization source is the synchronization source currently selected by the SL terminal, the SL terminal triggers transmission of a synchronization signal based on a local timing prior to selecting a second synchronization source. In some embodiments, the synchronization signal includes at least one of the SLSS or the S-SSB.

In some embodiments, in the case where the first synchronization source is a candidate synchronization source, the SL terminal detects and measures the second synchronization source.

For a case where the first synchronization source being available:

In some embodiments, in the process of measuring the first synchronization source, in the case where the second condition is not satisfied (which is considered as the first synchronization source being still located in the current region (visible) but the measurement being impossible due to excessive LBT failures), the SL terminal determines that the first synchronization source is available.

In some embodiments, in the case where the first synchronization source is available, the SL terminal continues to measure the first synchronization source. In this case, whether the first synchronization source has been selected as the synchronization source or the candidate synchronization source is not considered.

In some embodiments, a fourth condition is used for the SL terminal to determine, based on the measurement of the first synchronization source, whether the first synchronization source is available. The fourth condition includes at least one of:
measurement results are measured within the Q consecutive maximum measurement time durations;
measurement results are measured within the Y consecutive measurement periods; or.
a measurement result is measured within the first duration.

In some embodiments, in the process of measuring the first synchronization source in the SL-U, in the case where the fourth condition is not satisfied, the SL terminal determines that the first synchronization source is unavailable. In some embodiments, in the process of measuring the first synchronization source in the SL-U, in the case where the fourth condition is satisfied, the SL terminal determines that the first synchronization source is available. For the behavior of the SL terminal in the case where the first synchronization source is available or unavailable and related values in the fourth condition, reference may be made to the foregoing descriptions, which are not repeated herein in the embodiments of the present disclosure.

In summary, the method according to the embodiments determines, based on the second condition, whether the synchronization source measured by the SL terminal is available, and further determines, based on the determination result, whether to stop measuring the synchronization source, such that repeated measurements of the same synchronization source are avoided, and the overhead of the SL terminal is reduced.

FIG. 7 is a flowchart of a method for evaluation according to some exemplary embodiments of the present disclosure. The method is performed by an SL terminal. The method includes the following process.

In S702, an evaluation time duration is extended by Z, wherein Z is a positive integer.

The evaluation time duration is used for evaluating a measurement result of a currently selected synchronization source in an SL-U, and an evaluation result is used for triggering transmission of a synchronization signal of the SL terminal. That is, the SL terminal determines, based on the evaluation result, whether to transmit the synchronization signal. In some embodiments, the synchronization signal includes at least one of the SLSS or the S-SSB. Z is related to X (X is a positive integer), X is used for extending a measurement time duration to a maximum measurement time duration, and the measurement time duration is used for measuring the synchronization source. For descriptions of the measurement time duration and X, reference may be made to the embodiments illustrated in FIG. 6, which are not repeated herein in the present disclosure.

In some embodiments, Z is an even multiple of X. In some embodiments, Z is twice X.

The evaluation time duration includes a plurality of evaluation periods. In some embodiments, the evaluation period includes at least one of an SLSS period, an S-SSB period, or an SL-DRX cycle. In some embodiments, in the case where the SL terminal fails to evaluate the measurement result of the synchronization source within an un-extended evaluation time duration, the SL terminal extends the evaluation time duration in a unit of the evaluation period and continues the evaluation to determine whether to trigger the transmission of the synchronization signal of the SL terminal.

In some embodiments, the evaluation time duration is represented as (4+x)*synchronization signal period or (4+x)*SL-DRX cycle. x represents a number of extensions of the evaluation periods, that is, the number of evaluation periods extended on the basis of four evaluation periods (evaluation time duration without extension). The number of extensions is equivalent to/replaceable with an extension quantity, that is, a maximum number of extended evaluation periods (extending by one evaluation period each time) on the basis of four evaluation periods. x<x_max. Here, x_max represents a maximum number of extensions of the evaluation periods. In some embodiments, x_max=2*y_max, where y_max represents X.

For the case where the synchronization source is evaluated as unavailable:

In some embodiments, in the case where the synchronization source is unavailable (which is considered as the synchronization source (synchronization reference terminal) being no longer located in the current region (invisible), rather than the LBT failure), the SL terminal considers that no synchronization source exists. In this case, the SL terminal triggers the transmission of the synchronization signal.

For the case where the synchronization source is evaluated as available but the measurement result is unreliable:

In some embodiments, the synchronization source being available includes two cases: (1) The synchronization source is measurable each time. In this case, the SL terminal directly determines whether to transmit the synchronization signal by comparing the measured RSRP result to a threshold value. (2) Although the RSRP result of the synchronization source is measured, the measurement of the synchronization source fails to satisfy a measurement requirement (that is, the measurement result is unreliable). In some embodiments, the failure to satisfy the measurement requirement includes a case where an actual number of measurements for the synchronization source is less than a required number of measurements. For example, the requirement is four periods, but the measurement is actually performed only within two periods. The following behaviors of the SL terminal according to the embodiments of the present disclosure is applicable to case (2). It should be noted that, the following behaviors of the SL terminal according to the embodiments of the present disclosure are also applicable to case (1).

In some embodiments, in the case where the synchronization source is available (which is considered as the synchronization source being still located in the current region (visible) but an accurate evaluation of the measurement result being impossible due to excessive LBT failures), the SL terminal maintains the current transmission behavior of the synchronization signal. For example, in the case where the SL terminal determines, based on a reliable measurement result, that the synchronization signal needs to be transmitted, the SL terminal continues to transmit the synchronization signal. Alternatively, the SL terminal determines, based on a latest valid measurement result, whether to transmit the synchronization signal. In some embodiments, the measurement result refers to the PSBCH-RSRP.

In some embodiments, in the case where the synchronization source is available, the SL terminal determines, based on a terminal capability, whether to transmit the synchronization signal. In some embodiments, the terminal capability is an existing terminal capability. For example, an SL terminal that needs to save energy chooses not to transmit the synchronization signal. In some embodiments, the terminal capability is a terminal capability newly introduced for the scenario.

In some embodiments, in the case where the synchronization source is available, the SL terminal determines, based on pre-configuration information or signaling from a network device, whether to transmit the synchronization signal.

In some embodiments, in the case where the synchronization source is available, the SL terminal determines, based on a synchronization source priority or a type of the synchronization source, whether to transmit the synchronization signal. In some embodiments, in the case where the synchronization source priority of the synchronization source is higher than a priority threshold, the synchronization signal is transmitted; or in the case where the synchronization source priority of the synchronization source is lower than the priority threshold, the synchronization signal is not transmitted.

In some embodiments, a manner of determining the priority threshold includes at least one of:
the priority threshold being predetermined;
the priority threshold being determined based on a terminal capability; or
the priority threshold being configured by a network device.

In some embodiments, in the case where the synchronization source is available, the SL terminal evaluates, using a currently inaccurate measurement, whether to transmit the synchronization signal.

In some embodiments, in the case where the synchronization source is available, the transmission of the synchronization signal is triggered. That is, regardless of the value of the measurement result, the transmission of the synchronization signal is triggered.

In some embodiments, the above behaviors of the SL terminal in the case where the synchronization source is available are freely combined and applied. For example, the SL terminal transmits the synchronization signal only in the case where signaling configuration and priority conditions are satisfied. The synchronization signal is not transmitted in the case where either of the conditions is not satisfied.

For the above implementations of determining whether the synchronization source is available, reference may be made to the second condition in the embodiments illustrated in FIG. 6, which are not repeated herein in the present disclosure. It should be noted that, in the process of evaluating whether the synchronization source is available, in the case where the second condition in the embodiments illustrated in FIG. 6 is used for determination, the same or different numerical values as those of the second condition in the embodiments illustrated in FIG. 6 are used.

In summary, the method according to the embodiments clarifies the mode for extending the evaluation time duration in evaluating the synchronization source in the SL-U to clarify the manner of determining the evaluation time duration in the SL-U. By correlating the extension of the evaluation time duration with the measurement time duration, a mode for properly setting the evaluation time duration is provided, which helps clarify the related behaviors of the SL terminal through evaluation in the evaluation time duration.

The method according to the embodiments of the present disclosure provides determination modes for time durations and terminal behaviors for three RRM-related procedures in the SL-U, which include:
(1) a solution related to detecting the synchronization source;
(2) a solution related to measuring the synchronization source; and
(3) a method related to evaluating the synchronization source.

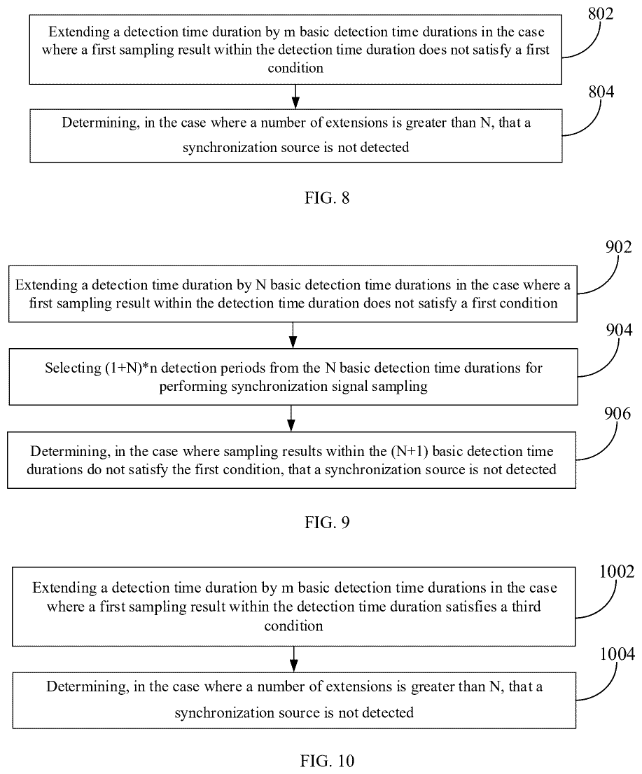

For the above solution (1), in the case where the detection time duration is gradually extended, FIG. 8 is a flowchart of a method for detection according to some exemplary embodiments of the present disclosure. The method is performed by an SL terminal. The method includes the following processes.

In S802, a detection time duration is extended by m basic detection time durations in the case where a first sampling result within the detection time duration does not satisfy a first condition.

m is a positive integer. The detection time duration is used for the SL terminal to detect a synchronization source via an SL-U. It should be noted that, in the embodiments of the present disclosure, detection is equivalent to/replaceable with discovery/probing.

The detection time duration includes a plurality of basic detection time durations. In some embodiments, the basic detection time duration includes at least one of:
one or more SLSS periods;
one or more S-SSB periods; or
one or more SL-DRX cycles.

In some embodiments, in the case where the detection time duration is not extended, the detection time duration includes one or more basic detection time durations, for example, includes only one basic detection time duration. The basic detection time duration is used for extending the detection time duration, for example, to extend the detection time duration in a unit of the basic detection time duration. For the process of extending the detection time duration, reference may be made to the following descriptions.

In some embodiments, each basic detection time duration includes one or more detection periods. The detection period includes at least one of an SLSS period, an S-SSB period, or an SL-DRX cycle. In some embodiments, the first sampling result includes a sampling result for a synchronization signal. The synchronization signal is transmitted by the synchronization source and is used for detecting the synchronization source. The synchronization signal includes at least one of:
an SLSS; or
an S-SSB.

In some embodiments, in the case where the un-extended detection time duration includes one basic detection time duration, the case where the detection time duration includes the plurality of basic detection time durations is acquired by extending the un-extended detection time duration. In this case, the detection time duration including the plurality of basic detection time durations is an extended detection time duration. For example, the detection time duration includes two basic detection time durations. One of the two basic detection time durations is a basic detection time duration in the detection time duration without extension, and the other basic detection time duration is used for extending the detection time duration. In some embodiments, the detection time duration includes one basic detection time duration. In this case, the detection time duration is not extended. The extension of the detection time duration is performed with reference to the following solution.

The first sampling result is determined based on second sampling results within one or more (or each) of the plurality of basic detection time durations. In this solution, the SL terminal combines the second sampling results within different basic detection time durations to determine whether the detection time duration needs to be extended. However, in the solution mentioned in the Background, in determining whether to extend the detection time duration, only the sampling result within the latest extended basic detection time duration is considered, but the sampling results within previous basic detection time durations are completely dropped. The above solution according to the embodiments of the present disclosure may reduce the detection time duration used by the SL terminal, thereby reducing terminal overheads.

In some embodiments, m equals 1. That is, for each extension of the detection time duration, the detection time duration is extended by only one basic detection time duration. It should be noted that the number of basic detection time durations used for each extension of the detection time duration is the same or different.

In some embodiments, in the case where the first sampling result within the detection time duration satisfies the first condition, the SL terminal stops extending the detection time duration and determines that the synchronization source is detected.

In some embodiments, the first sampling result includes the sampling result for the synchronization signal. Each basic detection time duration is used for sampling the synchronization signal for n times. n is a positive integer. In some embodiments, n equals 3. In some embodiments, in synchronization signal sampling within the basic detection time duration, the SL terminal randomly selects n detection periods to perform sampling for n times. It should be noted that although the SL terminal intends to perform sampling for n times, an actual sampling number is affected by the actual situation of the synchronization source, resulting in the actual sampling number in the basic detection time duration failing to reach n.

In some embodiments, the above synchronization signal includes at least one of the SLSS or the S-SSB.

In some embodiments, the first condition includes at least one of:
a cumulative sampling number for the synchronization signal within the detection time duration is greater than or equal to K; or
a time interval between two consecutive synchronization signal samplings does not exceed P, where P is a positive integer.

In some embodiments, the two consecutive synchronization signal samplings refer to any two consecutive synchronization signal samplings in a plurality of synchronization signal samplings that satisfy the cumulative sampling number.

In some embodiments, a manner of determining K includes at least one of:
K being predetermined;
K being determined based on a terminal capability; or
K being configured by a network device.

In some embodiments, a manner of determining P includes at least one of:
P being predetermined;
P being determined based on a terminal capability; or
P being configured by a network device.

In some embodiments, a number of extensions corresponding to the detection time duration is less than N, that is, the number of extensions of the detection time duration should not exceed a limit of N. The number of extensions is a cumulative number of times that the detection time duration has been extended by the basic detection time duration. The number of extensions is equivalent to/replaceable with a number of extensions, and the number of extensions is a cumulative number of times that the detection time duration has been extended by the basic detection time duration.

In some embodiments, N is related to an SL-DRX configuration. In some embodiments, in the case of non-SL-DRX or in a case where an SL-DRX cycle is less than a first value, N is a first numerical value. In some embodiments, in the case where the SL-DRX cycle is greater than the first value, N is a second numerical value. In some embodiments, the first numerical value is different from the second numerical value. For example, the first numerical value is greater than the second numerical value.

In some embodiments, N is related to the synchronization source priority of the current synchronization source of the SL terminal. In some embodiments, in the case where the current synchronization source of the SL terminal is the synchronization reference terminal, and a synchronization source to which the synchronization reference terminal is directly or indirectly synchronized is synchronized to the synchronization source with the highest synchronization source priority, N is the first numerical value. In some embodiments, in the case where the current synchronization source of the SL terminal is the synchronization reference terminal, and a synchronization source to which the synchronization reference terminal is directly or indirectly synchronized has a timing different from that of the synchronization source with the highest synchronization source priority, N is a third numerical value. In some embodiments, the third numerical value is different from the first numerical value and the second numerical value. For example, the third numerical value is greater than the first numerical value.

In S804, in the case where the number of extensions is greater than N, it is determined that the synchronization source is not detected.

In some embodiments, for a synchronous scenario, the GNSS has the highest synchronization source priority, and the current synchronization source of the SL terminal is another synchronization reference terminal that is directly or indirectly synchronized to the GNSS. In this case, the SL terminal only needs to search for other synchronous synchronization sources.

The detection time duration is extended by 1.6 s (the basic detection time duration). In this case, the detection time duration in the SL-U is represented as T_{detect}=(1.6+1.6*x1). For the extension process of the detection time duration, the SL terminal gradually extends the detection time duration based on the sampling result of the synchronization signal, and sets a stop condition for extension of the detection time duration. The SL terminal keeps performing detection in any three detection periods (S-SSB periods) within 1.6 s, with a maximum synchronization signal transmission dropping (SLSS Tx dropping) probability of 30% within each 1.6 s. However, the detection stop condition is that the SL terminal acquires a reliable/valid S-SSB detection result (satisfying the first condition). First, x1=0. The SL terminal initially selects three detection periods for detection within the first 1.6 s. In the case where the number of available detection periods is less than three, x1=x1+1, and the SL terminal starts detection in the second 1.6 s, where three detection periods are randomly selected similarly. This process continues until a reliable/valid sampling result is detected or x1 exceeds x1_max. The condition that needs to be satisfied by the reliable/valid sampling result includes at least one of:
The sampling number is greater than or equal to Ns, where Ns is a fixed value, such as 3. Alternatively, Ns is determined based on a terminal capability, a configuration, or the like. Generally, the numerical value of Ns should be greater than or equal to 2.
An interval between two consecutive samplings should be less than Tmax, for example, Tmax=1.6 s. Alternatively, Tmax is determined based on a terminal capability, a configuration, or the like. In this way, the validity for combining a plurality of sampling results is ensured. (In the case where the time interval between two samplings is very large, it is very likely that the two samplings are not transmitted by the same synchronization reference terminal, or the status of the synchronization reference terminal has changed significantly, so the results of the two samplings cannot be combined.)

In some embodiments, the SL terminal extends the detection time duration in a unit of the detection period. However, this leads to an increased interruption probability. In this case, the maximum extension value needs to be limited. The detection time duration is represented as T_{detect}=(1.6+0.16*x1). In some embodiments, x1_max=4 for this case, corresponding to a maximum interruption probability of 50%.

In some embodiments, for an asynchronous scenario, the GNSS has the highest synchronization source priority, and the current synchronization source of the SL terminal is another synchronization reference terminal that is directly or indirectly synchronized to the cell. In this case, the SL terminal needs to search for other asynchronous synchronization sources.

The basic detection time duration is 8 s=50*160 ms detection period, during which dropping of 6% of V2X data and reference signal transmissions is allowed.

The SL terminal gradually extends the detection time duration based on the sampling result, and sets a stop condition for extension of the detection time duration. The detection is kept in any three detection periods within 8 s, with a maximum synchronization signal transmission dropping (SLSS Tx dropping) probability of 6% within each 8 s. However, the detection stop condition is that the SL terminal acquires a reliable/valid sampling result of the synchronization signal. The detection time duration is (8+8*x2). Initially, x2=0. In the case where no reliable detection result is detected within the first 8 s, x2 is increased by 1. This process continues until the SL terminal acquires a reliable sampling result (satisfying the first condition).

In some embodiments, the SL terminal extends the detection time duration in a unit of the detection period. However, this leads to an increased interruption probability. In this case, the maximum extension value needs to be limited. The detection time duration is represented as T_{detect}=(8+0.16*x1). In some embodiments, x2_max=3 for this case, corresponding to a maximum interruption probability of 11.32%.

In some embodiments, different values of x1_max/x2_max are set for different SL-DRX configurations. For example, in the case of no SL-DRX or an SL-DRX cycle being less than 320 ms, x1_max/x2 max=4; and in the case where the SL-DRX cycle is greater than 320 ms, x1 max/x2_max=2. In some embodiments, different values are set for different synchronization source scenarios. For example, x1_max=4 in a synchronous scenario, and x2_max=8 in an asynchronous scenario.

In the embodiments, S802 and S804 are optional. In different embodiments, one or more of these processes are omitted or replaced.

S802 may be implemented as an independent embodiment, for example, separately implemented as a method for detecting a synchronization source performed by the SL terminal. S804 may be implemented as an independent embodiment, for example, separately implemented as a method for determining a synchronization source performed by the SL terminal.

In summary, the method according to the embodiments clarifies the manner of determining the detection time duration in the SL-U by clarifying the mode for extending the detection time duration in detecting the synchronization source in the SL-U, and thus provides the implementation of detecting the synchronization source in the SL-U.

Moreover, the first sampling result is determined based on second sampling results within one or more (or each) of the plurality of basic detection time durations. This solution may reduce the detection time duration used by the SL terminal, thereby reducing terminal overheads. In addition, the method according to the embodiments of the present disclosure clarifies the conditions for determining whether the synchronization source is detected, which may improve the accuracy of detecting the synchronization source.

For the above solution (1), in the case of directly extending to the maximum detection time duration, FIG. 9 is a flowchart of a method for detection according to some exemplary embodiments of the present disclosure. The method is performed by an SL terminal. The method includes the following processes.

In S902, a detection time duration is extended by N basic detection time durations in the case where a first sampling result within the detection time duration does not satisfy a first condition.

The detection time duration is used for the SL terminal to detect a synchronization source via an SL-U. It should be noted that, in the embodiments of the present disclosure, detection is equivalent to/replaceable with discovery/probing.

The extended detection time duration includes the (N+1) basic detection time durations. In some embodiments, the basic detection time duration includes at least one of:
one or more SLSS periods;
one or more S-SSB periods; or
one or more SL-DRX cycles.

In some embodiments, in the case where the detection time duration is not extended, the detection time duration includes one or more basic detection time durations, for example, includes only one basic detection time duration. The basic detection time duration is used for extending the detection time duration, for example, to extend the detection time duration in a unit of the basic detection time duration. For the process of extending the detection time duration, reference may be made to the following descriptions.

In some embodiments, each basic detection time duration includes one or more detection periods. The detection period includes at least one of an SLSS period, an S-SSB period, or an SL-DRX cycle. In some embodiments, the first sampling result includes a sampling result for a synchronization signal. The synchronization signal is transmitted by the synchronization source and is used for detecting the synchronization source. The synchronization signal includes at least one of:
an SLSS; or
an S-SSB.

In some embodiments, in the case where the first sampling result within the detection time duration does not satisfy the first condition, the SL terminal extends the detection time duration by the N basic detection time durations. The extended detection time duration includes (N+1) basic detection time durations. In some embodiments, the detection time duration before extension includes only one basic detection time duration.

In some embodiments, the first condition includes at least one of:
a cumulative sampling number for the synchronization signal within the detection time duration is greater than or equal to K; or
a time interval between two consecutive synchronization signal samplings does not exceed P, where P is a positive integer.

In the above solution, in sampling the synchronization signal, the numbers of detection periods selected by the SL terminal from different basic detection time durations are different. In addition, the SL terminal further combines the sampling results within different basic detection time durations to determine, based on the first condition, whether the synchronization source is detected. However, in the solution mentioned in the Background, in sampling the synchronization signal, the numbers of detection periods selected from different basic detection time durations are the same, and only the sampling result within a basic detection time duration is considered. The above solution according to the embodiments of the present disclosure may improve the flexibility of sampling the synchronization signal, thereby improving the possibility of detecting the synchronization source.

In some embodiments, N is related to an SL-DRX configuration. In some embodiments, in the case of non-SL-DRX or in a case where an SL-DRX cycle is less than a first value, N is a first numerical value. In some embodiments, in the case where the SL-DRX cycle is greater than the first value, N is a second numerical value.

In some embodiments, N is related to the synchronization source priority of the current synchronization source of the terminal. In some embodiments, in the case where the current synchronization source of the SL terminal is the synchronization reference terminal, and a synchronization source to which the synchronization reference terminal is directly or indirectly synchronized is synchronized to the synchronization source with the highest synchronization source priority, N is the first numerical value. In some embodiments, in the case where the current synchronization source of the SL terminal is the synchronization reference terminal, and a synchronization source to which the synchronization reference terminal is directly or indirectly synchronized has a timing different from that of the synchronization source with the highest synchronization source priority, N is a third numerical value. In some embodiments, the third numerical value is different from the first numerical value and the second numerical value.

In some embodiments, a manner of determining K includes at least one of:
K being predetermined;
K being determined based on a terminal capability; or
K being configured by a network device.

In some embodiments, a manner of determining P includes at least one of:
P being predetermined;
P being determined based on a terminal capability; or
P being configured by a network device.

In S904, (1+N)*n detection periods are selected from the (N+1) basic detection time durations for performing synchronization signal sampling.

n is a positive integer. In some embodiments, the first sampling result includes the sampling result for the synchronization signal. Each basic detection time duration includes one or more detection periods. In some embodiments, the detection period includes at least one of an SLSS period, an S-SSB period, or an SL-DRX cycle. The SL terminal selects (1+N)*n detection periods from (N+1) basic detection time durations for performing synchronization signal sampling. n is a positive integer. In some embodiments, the numbers of detection periods selected by the SL terminal from different basic detection time durations are the same or different. In some embodiments, n equals 3. In some embodiments, the SL terminal randomly selects (1+N)*n detection periods from the detection time duration. In some embodiments, the above synchronization signal includes at least one of the SLSS or the S-SSB.

In S906, in the case where sampling results within the (N+1) basic detection time durations do not satisfy the first condition, it is determined that the synchronization source is not detected.

In some embodiments, for a synchronous scenario, the GNSS has the highest synchronization source priority, and the current synchronization source of the SL terminal is another synchronization reference terminal that is directly or indirectly synchronized to the GNSS. In this case, the SL terminal only needs to search for other synchronous synchronization sources.

The SL terminal fixedly extends the detection time duration to T_{detect}=(1.6+1.6*x1_max). x1 max is not determined based on the number of basic detection time durations with actual determination of failure, but is a fixed value. Within the period T detect, the SL terminal randomly selects (1+x1_max)*3 detection periods for detection, and the dropping probability of transmission of the synchronization signal remains 30% (remains 30% throughout the entire 1.6+1.6*x1_max, although the dropping probability within 1.6 s exceeds or falls below the proportion). In the case where no reliable/valid synchronization signal is detected within the fixedly extended period T_{detect}=(1.6+1.6*x1_max), no candidate synchronization reference terminal is detected.

In some embodiments, the SL terminal extends the detection time duration in a unit of the detection period. However, this leads to an increased interruption probability. In this case, the maximum extension value needs to be limited. The detection time duration is represented as T_{detect}=(1.6+0.16*x1). In some embodiments, x1_max=4 for this case, corresponding to a maximum interruption probability of 50%.

In some embodiments, for an asynchronous scenario, the GNSS has the highest synchronization source priority, and the current synchronization source of the SL terminal is another synchronization reference terminal that is directly or indirectly synchronized to the cell. In this case, the SL terminal needs to search for other asynchronous synchronization sources.

The basic detection time duration is 8 s=50*160 ms detection period, during which dropping of 6% of V2X data and reference signal transmissions is allowed.

The detection time duration is fixedly extended to (8+8*x2_max). In some embodiments, the SL terminal randomly selects 3+3*x2_max detection periods from the fixed detection time duration of (8+8*x2_max) for detection. This ensures a maximum dropping probability of V2X data and reference signal transmissions of 6% within the period of (8+8*x2_max). In some embodiments, the SL terminal randomly selects three detection periods from each 8 s for detection. This ensures a dropping probability of V2X data and reference signal transmissions of 30% within each 8 s.

In some embodiments, the SL terminal extends the detection time duration in a unit of the detection period. However, this leads to an increased interruption probability. In this case, the maximum extension value needs to be limited. The detection time duration is represented as T_{detect}=(8+0.16*x1). In some embodiments, x2_max=3 for this case, corresponding to a maximum interruption probability of 11.32%.

In some embodiments, different values of x1_max/x2_max are set for different SL-DRX configurations. For example, in the case of no SL-DRX or an SL-DRX cycle being less than 320 ms, x1 max/x2_max=4; and in the case where the SL-DRX cycle is greater than 320 ms, x1 max/x2 max=2. In some embodiments, different values are set for different synchronization source scenarios. For example, x1_max=4 in a synchronous scenario, and x2_max=8 in an asynchronous scenario.

In the embodiments, S902, S904, and S906 are optional. In different embodiments, one or more of these processes are omitted or replaced.

S902 may be implemented as an independent embodiment, for example, separately implemented as a method for detecting a synchronization source performed by the SL terminal. S904 may be implemented as an independent embodiment, for example, separately implemented as a method for sampling a synchronization signal performed by the SL terminal. S906 may be implemented as an independent embodiment, for example, separately implemented as a method for determining a synchronization source performed by the SL terminal.

In summary, the method according to the embodiments clarifies the manner of determining the detection time duration in the SL-U by clarifying the mode for extending the detection time duration in detecting the synchronization source in the SL-U, and thus provides the implementation of detecting the synchronization source in the SL-U.

Moreover, in sampling the synchronization signal, the numbers of detection periods selected by the SL terminal for different basic detection time durations are different. In addition, the SL terminal further combines the sampling results within different basic detection time durations to determine, based on the first condition, whether the synchronization source is detected. This solution may improve the flexibility of sampling the synchronization signal, thereby improving the possibility of detecting the synchronization source. In addition, the method according to the embodiments of the present disclosure clarifies the conditions for determining whether the synchronization source is detected, which may improve the accuracy of detecting the synchronization source.

For the above solution (1), in the case where the detection time duration is gradually extended, FIG. 10 is a flowchart of a method for detection according to some exemplary embodiments of the present disclosure. The method is performed by an SL terminal. The method includes the following processes.

In S1002, a detection time duration is extended by m basic detection time durations in the case where a first sampling result within the detection time duration satisfies a third condition.

m is a positive integer. The detection time duration is used for the SL terminal to detect a synchronization source via an SL-U. It should be noted that, in the embodiments of the present disclosure, detection is equivalent to/replaceable with discovery/probing.

The detection time duration includes a plurality of basic detection time durations. In some embodiments, the basic detection time duration includes at least one of:
one or more SLSS periods;
one or more S-SSB periods; or
one or more SL-DRX cycles.

In some embodiments, in the case where the detection time duration is not extended, the detection time duration includes one or more basic detection time durations, for example, includes only one basic detection time duration. The basic detection time duration is used for extending the detection time duration, for example, to extend the detection time duration in a unit of the basic detection time duration. For the process of extending the detection time duration, reference may be made to the following descriptions.

In some embodiments, each basic detection time duration includes one or more detection periods. The detection period includes at least one of an SLSS period, an S-SSB period, or an SL-DRX cycle. In some embodiments, the first sampling result includes a sampling result for a synchronization signal. The synchronization signal is transmitted by the synchronization source and is used for detecting the synchronization source. The synchronization signal includes at least one of:
an SLSS; or
an S-SSB.

In some embodiments, in the case where the un-extended detection time duration includes one basic detection time duration, the case where the detection time duration includes the plurality of basic detection time durations is acquired by extending the un-extended detection time duration. In this case, the detection time duration including the plurality of basic detection time durations is an extended detection time duration. In some embodiments, the detection time duration includes one basic detection time duration. In this case, the detection time duration is not extended. The extension of the detection time duration is performed with reference to the following solution.

The first sampling result is determined based on second sampling results within one or more (or each) of the plurality of basic detection time durations. In this solution, the SL terminal combines the second sampling results within different basic detection time durations to determine whether the detection time duration needs to be extended. However, in the solution mentioned in the Background, in determining whether to extend the detection time duration, only the sampling result within the latest extended basic detection time duration is considered, but the sampling results within previous basic detection time durations are completely dropped. The above solution according to the embodiments of the present disclosure may reduce the detection time duration used by the SL terminal, thereby reducing terminal overheads.

In some embodiments, m equals 1. That is, for each extension of the detection time duration, the detection time duration is extended by only one basic detection time duration. It should be noted that the number of basic detection time durations used for each extension of the detection time duration is the same or different.

In some embodiments, in the case where the first sampling result within the detection time duration does not satisfy the third condition, the SL terminal stops extending the detection time duration and determines that the synchronization source is detected.

In some embodiments, the first sampling result includes the sampling result for the synchronization signal. Each basic detection time duration is used for sampling the synchronization signal for n times. n is a positive integer. In some embodiments, n equals 3. In some embodiments, in synchronization signal sampling in the basic detection time duration, the SL terminal randomly selects n detection periods to perform sampling for n times.

In some embodiments, the above synchronization signal includes at least one of the SLSS or the S-SSB.

In some embodiments, the third condition includes at least one of:
the cumulative sampling number for the synchronization signal within the detection time duration is less than K; or
the time interval between two consecutive synchronization signal samplings exceeds P.

In some embodiments, the two consecutive synchronization signal samplings refer to any two consecutive synchronization signal samplings in a plurality of synchronization signal samplings that satisfy the cumulative sampling number.

In some embodiments, a manner of determining K includes at least one of:
K being predetermined;
K being determined based on a terminal capability; or
K being configured by a network device.

In some embodiments, a manner of determining P includes at least one of:
P being predetermined;
P being determined based on a terminal capability; or
P being configured by a network device.

In some embodiments, a number of extensions corresponding to the detection time duration is less than N, that is, the number of extensions of the detection time duration should not exceed a limit of N. The number of extensions is a cumulative number of times that the detection time duration has been extended by the basic detection time duration. The number of extensions is equivalent to/replaceable with a number of extensions, and the number of extensions is a cumulative number of times that the detection time duration has been extended by the basic detection time duration.

In some embodiments, N is related to an SL-DRX configuration. In some embodiments, in the case of non-SL-DRX or in a case where an SL-DRX cycle is less than a first value, N is a first numerical value. In some embodiments, in the case where the SL-DRX cycle is greater than the first value, N is a second numerical value. In some embodiments, the first numerical value is different from the second numerical value. For example, the first numerical value is greater than the second numerical value.

In some embodiments, N is related to the synchronization source priority of the current synchronization source of the SL terminal. In some embodiments, in the case where the current synchronization source of the SL terminal is the synchronization reference terminal, and a synchronization source to which the synchronization reference terminal is directly or indirectly synchronized is synchronized to the synchronization source with the highest synchronization source priority, N is the first numerical value. In some embodiments, in the case where the current synchronization source of the SL terminal is the synchronization reference terminal, and a synchronization source to which the synchronization reference terminal is directly or indirectly synchronized has a timing different from that of the synchronization source with the highest synchronization source priority, N is a third numerical value. In some embodiments, the third numerical value is different from the first numerical value and the second numerical value. For example, the third numerical value is greater than the first numerical value.

In S1004, in the case where the number of extensions is greater than N, it is determined that the synchronization source is not detected.

In summary, the method according to the embodiments clarifies the manner of determining the detection time duration in the SL-U by clarifying the mode for extending the detection time duration in detecting the synchronization source in the SL-U, and thus provides the implementation of detecting the synchronization source in the SL-U.

Moreover, the first sampling result is determined based on second sampling results of one or more (or each) of the plurality of basic detection time durations. This solution may reduce the detection time duration used by the SL terminal, thereby reducing terminal overheads. In addition, the method according to the embodiments of the present disclosure clarifies the conditions for determining whether the synchronization source is detected, which may improve the accuracy of detecting the synchronization source.

For the above solution (1), in the case of directly extending to the maximum detection time duration, FIG. 11 is a flowchart of a method for detection according to some exemplary embodiments of the present disclosure. The method is performed by an SL terminal. The method includes the following processes.

In S1102, a detection time duration is extended by N basic detection time durations in the case where a first sampling result within the detection time duration satisfies a third condition.

The detection time duration is used for the SL terminal to detect a synchronization source via an SL-U. It should be noted that, in the embodiments of the present disclosure, detection is equivalent to/replaceable with discovery/probing.

The extended detection time duration includes the (N+1) basic detection time durations. In some embodiments, the basic detection time duration includes at least one of:
one or more SLSS periods;
one or more S-SSB periods; or
one or more SL-DRX cycles.

In some embodiments, in the case where the detection time duration is not extended, the detection time duration includes one or more basic detection time durations, for example, includes only one basic detection time duration. The basic detection time duration is used for extending the detection time duration, for example, to extend the detection time duration in a unit of the basic detection time duration. For the process of extending the detection time duration, reference may be made to the following descriptions.

In some embodiments, each basic detection time duration includes one or more detection periods. The detection period includes at least one of an SLSS period, an S-SSB period, or an SL-DRX cycle. In some embodiments, the first sampling result includes a sampling result for a synchronization signal. The synchronization signal is transmitted by the synchronization source and is used for detecting the synchronization source. The synchronization signal includes at least one of:
an SLSS; or
an S-SSB.

In some embodiments, in the case where the first sampling result within the detection time duration satisfies the third condition, the SL terminal extends the detection time duration by the N basic detection time durations. The extended detection time duration includes the (N+1) basic detection time durations. In some embodiments, the detection time duration before extension includes only one basic detection time duration.

In some embodiments, the third condition includes at least one of:
the cumulative sampling number for the synchronization signal within the detection time duration is less than K; or
the time interval between two consecutive synchronization signal samplings exceeds P.

In the above solution, in sampling the synchronization signal, the numbers of detection periods selected by the SL terminal from different basic detection time durations are different. In addition, the SL terminal further combines the sampling results within different basic detection time durations to determine, based on the third condition, whether the synchronization source is detected. However, in the solution mentioned in the Background, in sampling the synchronization signal, the numbers of detection periods selected from different basic detection time durations are the same, and only the sampling result within a basic detection time duration is considered. The above solution according to the embodiments of the present disclosure may improve the flexibility of sampling the synchronization signal, thereby improving the possibility of detecting the synchronization source.

In some embodiments, N is related to an SL-DRX configuration. In some embodiments, in the case of non-SL-DRX or in a case where an SL-DRX cycle is less than a first value, N is a first numerical value. In some embodiments, in the case where the SL-DRX cycle is greater than the first value, N is a second numerical value.

In some embodiments, N is related to the synchronization source priority of the current synchronization source of the terminal. In some embodiments, in the case where the current synchronization source of the SL terminal is the synchronization reference terminal, and a synchronization source to which the synchronization reference terminal is directly or indirectly synchronized is synchronized to the synchronization source with the highest synchronization source priority, N is the first numerical value. In some embodiments, in the case where the current synchronization source of the SL terminal is the synchronization reference terminal, and a synchronization source to which the synchronization reference terminal is directly or indirectly synchronized has a timing different from that of the synchronization source with the highest synchronization source priority, N is a third numerical value. In some embodiments, the third numerical value is different from the first numerical value and the second numerical value.

In some embodiments, a manner of determining K includes at least one of:
K being predetermined;
K being determined based on a terminal capability; or
K being configured by a network device.

In some embodiments, a manner of determining P includes at least one of:
P being predetermined;
P being determined based on a terminal capability; or
P being configured by a network device.

In S1104, (1+N)*n detection periods are selected from (N+1) basic detection time durations for performing synchronization signal sampling.

n is a positive integer. In some embodiments, the first sampling result includes the sampling result for the synchronization signal. Each basic detection time duration includes one or more detection periods. In some embodiments, the detection period includes at least one of an SLSS period, an S-SSB period, or an SL-DRX cycle. The SL terminal selects the (1+N)*n detection periods from the (N+1) basic detection time durations for performing synchronization signal sampling. n is a positive integer. In some embodiments, the numbers of detection periods selected by the SL terminal from different basic detection time durations are the same or different. In some embodiments, n equals 3. In some embodiments, the SL terminal randomly selects the (1+N)*n detection periods from the detection time duration. In some embodiments, the above synchronization signal includes at least one of the SLSS or the S-SSB.

In S1106, in the case where sampling results within the (N+1) basic detection time durations satisfy the third condition, it is determined that the synchronization source is not detected.

In some embodiments, in the case where the sampling results within the (N+1) basic detection time durations do not satisfy the third condition, the SL terminal determines that the synchronization source is detected.

In summary, the method according to the embodiments clarifies the manner of determining the detection time duration in the SL-U by clarifying the mode for extending the detection time duration in detecting the synchronization source in the SL-U, and thus provides the implementation of detecting the synchronization source in the SL-U.

Moreover, in sampling the synchronization signal, the numbers of detection periods selected by the SL terminal from different basic detection time durations are different. In addition, the SL terminal further combines the sampling results from different basic detection time durations to determine, based on the third condition, whether the synchronization source is detected. This solution may improve the flexibility of sampling the synchronization signal, thereby improving the possibility of detecting the synchronization source. In addition, the method according to the embodiments of the present disclosure clarifies the conditions for determining whether the synchronization source is detected, which may improve the accuracy of detecting the synchronization source.

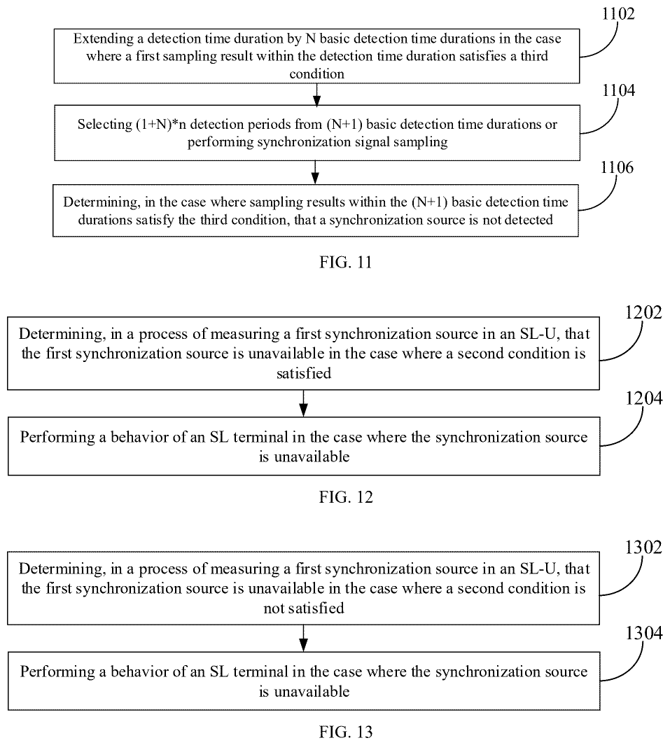

For the above solution (2), FIG. 12 is a flowchart of a method for measurement according to some exemplary embodiments of the present disclosure. The method is performed by an SL terminal. The method includes the following processes.

In S1202, it is determined, in a process of measuring a first synchronization source in an SL-U, that the first synchronization source is unavailable in the case where a second condition is satisfied.

The above second condition includes at least one of:
no measurement result being measured within Q consecutive maximum measurement time durations, wherein the maximum measurement time duration is acquired by extending a measurement time duration by X;
no measurement result being measured within Y consecutive measurement periods, where each measurement time duration includes a plurality of measurement periods; or
no measurement result being measured within a first duration.

The maximum measurement time duration includes a plurality of measurement periods. In some embodiments, the measurement period includes at least one of an SLSS period, an S-SSB period, or an SL-DRX cycle. In some embodiments, in the case where the SL terminal measures no measurement result within an un-extended measurement time duration, the SL terminal extends the measurement time duration in a unit of the measurement period and continues the measurement. Then, in the case where the measurement time duration is extended to the maximum measurement time duration but no measurement result is measured, the SL terminal performs the measurement again in the above manner. In some embodiments, the above second condition is used for determining whether to stop measuring the first synchronization source.

In some embodiments, no measurement result being measured refers to not measuring a sufficient number of measurement results, that is, an actual number of measurements does not satisfy a requirement.

In some embodiments, the maximum measurement time duration is acquired by extending the measurement time duration by a maximum number of measurement periods. In some embodiments, measuring the first synchronization source refers to measuring a PSBCH-RSRP of the first synchronization source.

In some embodiments, the maximum measurement time duration is represented as (2+y_max)*160 or (2+y_max)*SL-DRX cycle. 160 ms refers to the SLSS period, and y_max represents a maximum number of extensions, that is, a maximum number of measurement periods extended on the basis of two measurement periods (measurement time duration without extension).

The maximum number of extensions is equivalent to/replaceable with a maximum number of extensions, that is, a maximum number of extended measurement periods (extending by one measurement period each time) on the basis of two measurement periods (measurement time duration without extension). In some embodiments, y_max=2.

In some embodiments, a manner of determining Q (Q is a positive integer) includes at least one of:
Q being predetermined;
Q being determined based on a terminal capability;
Q being configured by a network device;
Q being determined based on a synchronization source priority or a type of the first synchronization source; or.

Q being determined based on a synchronization source priority or a type of the synchronization source currently selected by the terminal.

In some embodiments, a manner of determining Y includes at least one of:
Y being predetermined;
Y being determined based on a terminal capability;
Y being configured by a network device;
Y being determined based on a synchronization source priority or a type of the first synchronization source; or
Y being determined based on a synchronization source priority or a type of the synchronization source currently selected by the terminal.

In some embodiments, a manner of determining the first duration includes at least one of:
the first duration being predetermined;
the first duration being determined based on a terminal capability;
the first duration being configured by a network device;
the first duration being determined based on a synchronization source priority or a type of the first synchronization source; or
the first duration being determined based on a synchronization source priority or a type of the synchronization source currently selected by the terminal.

It should be noted that, in the embodiments of the present disclosure, the determination modes for Q, Y, and the first duration are completely the same, partially the same, or completely different.

In S1204, a behavior of the SL terminal in the case where the synchronization source is unavailable is performed.

In some embodiments, the first synchronization source is the synchronization reference terminal. In some practices, in the case where the SL terminal measures the first synchronization source, an extension parameter of the measurement time duration exceeds a maximum extension parameter due to an LBT failure/the synchronization reference terminal being no longer located in the current region (invisible). In this case, the SL terminal in some practices endlessly re-measures the first synchronization source, resulting in high overheads of the SL terminal. The method according to the embodiments of the present disclosure introduces the second condition to stop the measurement of the synchronization source to avoid endless repeated measurements of the same synchronization source, and provides the behavior of the SL terminal in the case where the second condition is satisfied. The content is as follows.

In some embodiments, in the case where the first synchronization source is unavailable (the second condition being satisfied is considered as the first synchronization source being no longer located in the current region (invisible), rather than the LBT failure), the SL terminal stops measuring the first synchronization source.

In some embodiments, in the case where the first synchronization source is the synchronization source currently selected by the SL terminal, the SL terminal triggers synchronization source detection.

In some embodiments, in the case where the first synchronization source is the synchronization source currently selected by the SL terminal, the status of the SL terminal changes from having the first synchronization source (synchronization reference terminal) as the synchronization source to having no synchronization source.

In some embodiments, in the case where the first synchronization source is the synchronization source currently selected by the SL terminal, the SL terminal triggers transmission of a synchronization signal based on a local timing prior to selecting a second synchronization source. In some embodiments, the synchronization signal includes at least one of the SLSS or the S-SSB.

In some embodiments, in the case where the first synchronization source is a candidate synchronization source, the SL terminal detects and measures the second synchronization source.

In some embodiments, in the process of measuring the first synchronization source, in the case where the second condition is not satisfied (which is considered as the first synchronization source being still located in the current region (visible) but the measurement being impossible due to excessive LBT failures), the SL terminal determines that the first synchronization source is available.

In some embodiments, in the case where the first synchronization source is available, the SL terminal continues to measure the first synchronization source. In this case, whether the first synchronization source has been selected as the synchronization source or the candidate synchronization source is not considered.

In some embodiments, the maximum extension parameter for the PSBCH-RSRP measurement time duration of the synchronization source is set to y_max=2.

In the case where the extension parameter y exceeds y_max, the behavior of the SL terminal is as follows.

In the case where the extension parameter y exceeds y_max for the first time, the SL terminal re-measures the same synchronization reference terminal. In addition, a condition for stopping the measurement needs to be introduced to prevent endless re-measurement. The condition is a combination of one or more of:
The extension parameter exceeds y_max within N1y consecutive PSBCH-RSRP measurement time durations. For example, each maximum PSBCH-RSRP measurement time duration is (2+y_max) measurement periods, and the SL terminal measures synchronization reference terminal 1 within a first group of four measurement periods and determines that measurement of the PSBCH-RSRP is failed due to the LBT failure (y exceeds y_max), and then restarts the measurement of the synchronization reference terminal 1. The PSBCH-RSRP is further not measured within a second group of four measurement periods. Assuming that N1y=2, then the PSBCH-RSRP result is not measured within Ny=2 consecutive PSBCH-RSRP measurement time durations, and it is highly probable that the synchronization signal is not transmitted due to the synchronization reference terminal 1 being unavailable (for example, moving out of the region, or stopping transmitting the synchronization signal, or for other reasons), rather than due to the LBT failure.
The PSBCH-RSRP is not measured within N2y consecutive measurement periods. The numerical value of N2y should be larger, for example, N2y=8, such that an effect similar to that in the example in the previous condition is achieved. The numerical value of N2y may not be a multiple of (2+y_max). For example, N2y=6.
The SL terminal fails to measure the corresponding synchronization reference terminal within the time Ty. That is, the PSBCH-RSRP is not measured for a long period of time. In the case where Ty=N1y*(2+y_max)*max (S-SSB period, SL-DRX cycle), the two solutions are equivalent. In the case where Ty is not an integer multiple of the PSBCH-RSRP measurement time duration, the two solutions are slightly different.

In the case where the second condition is satisfied (i.e., the prolonged failure to measure the corresponding synchronization reference terminal is likely due to the synchronization reference terminal leaving the current region, stopping transmitting the synchronization signal, or the like), the SL terminal determines that the synchronization reference terminal is unavailable, and needs to stop measuring the synchronization reference terminal. The corresponding behavior of the SL terminal includes:

(1) For the synchronization reference terminal that has currently been selected as the synchronization source, in the case where the current synchronization source is unavailable, the SL terminal has no selected synchronization reference terminal. The behavior of the SL terminal includes:
a. triggering a search for a synchronization source;
b. triggering the transmission of the synchronization signal based on a local timing before selecting another synchronization source; and
c. performing the above two behaviors in the case where the SL terminal considers that no synchronization source exists, without making additional modifications to the current protocol, but only clarifying the condition/case under which the SL terminal has no synchronization reference terminal.

(2) For a candidate synchronization reference terminal, the SL terminal stops measuring the candidate synchronization reference terminal, and searches for and measures other synchronization sources.

In the case where the second condition is not satisfied, the SL terminal determines that the synchronization reference terminal is still available, but the synchronization signal fails to be transmitted only due to LBT. The SL terminal further re-measures the synchronization reference terminal.

In the embodiments, S1202 and S1204 are optional. In different embodiments, one or more of these processes are omitted or replaced.

S1202 may be implemented as an independent embodiment, for example, separately implemented as a method for measuring a synchronization source performed by the SL terminal. S1204 may be implemented as an independent embodiment, for example, separately implemented as a method for measuring a synchronization source performed by the SL terminal.

In summary, the method according to the embodiments determines, based on the second condition, whether the synchronization source measured by the SL terminal is available, and further determines, based on the determination result, whether to stop measuring the synchronization source, such that repeated measurements of the same synchronization source are avoided, and the overhead of the SL terminal is reduced. Moreover, the method according to the embodiments further clarifies the behavior of the SL terminal in the case where the second condition is satisfied and the behavior of the SL terminal in the case where the second condition is not satisfied.

For the above solution (2), FIG. 13 is a flowchart of a method for measurement according to some exemplary embodiments of the present disclosure. The method is performed by an SL terminal. The method includes the following processes.

In S1302, it is determined, in a process of measuring a first synchronization source in an SL-U, that the first synchronization source is unavailable in the case where a fourth condition is not satisfied.

The fourth condition includes at least one of:
measurement results are measured within Q consecutive maximum measurement time durations;
measurement results are measured within Y consecutive measurement periods; or
a measurement result is measured within a first duration.

The maximum measurement time duration includes a plurality of measurement periods. In some embodiments, the measurement period includes at least one of an SLSS period, an S-SSB period, or an SL-DRX cycle. In some embodiments, in the case where the SL terminal measures no measurement result within an un-extended measurement time duration, the SL terminal extends the measurement time duration in a unit of the measurement period and continues the measurement. Then, in the case where the measurement time duration is extended to the maximum measurement time duration but no measurement result is measured, the SL terminal performs the measurement again in the above manner. In some embodiments, the above fourth condition is used for determining whether to stop measuring the first synchronization source.

In some embodiments, no measurement result being measured refers to not measuring a sufficient number of measurement results, that is, an actual number of measurements does not satisfy a requirement.

In some embodiments, the maximum measurement time duration is acquired by extending the measurement time duration by a maximum number of measurement periods. In some embodiments, measuring the first synchronization source refers to measuring a PSBCH-RSRP of the first synchronization source.

In some embodiments, the maximum measurement time duration is represented as (2+y_max)*160 or (2+y_max)*SL-DRX cycle. 160 ms refers to the SLSS period, and y_max represents a maximum number of extensions, that is, a maximum number of measurement periods extended on the basis of two measurement periods (measurement time duration without extension). The maximum number of extensions is equivalent to/replaceable with a maximum number of extensions, that is, a maximum number of extended measurement periods (extending by one measurement period each time) on the basis of two measurement periods (measurement time duration without extension). In some embodiments, y_max=2.

In some embodiments, a manner of determining Q (Q is a positive integer) includes at least one of:
Q being predetermined;
Q being determined based on a terminal capability;
Q being configured by a network device;
Q being determined based on a synchronization source priority or a type of the first synchronization source; or.

Q being determined based on a synchronization source priority or a type of the synchronization source currently selected by the terminal.

In some embodiments, a manner of determining Y includes at least one of:
Y being predetermined;
Y being determined based on a terminal capability;
Y being configured by a network device;
Y being determined based on a synchronization source priority or a type of the first synchronization source; or
Y being determined based on a synchronization source priority or a type of the synchronization source currently selected by the terminal.

In some embodiments, a manner of determining the first duration includes at least one of:
the first duration being predetermined;
the first duration being determined based on a terminal capability;
the first duration being configured by a network device;
the first duration being determined based on a synchronization source priority or a type of the first synchronization source; or
the first duration being determined based on a synchronization source priority or a type of the synchronization source currently selected by the terminal.

It should be noted that, in the embodiments of the present disclosure, the determination modes for Q, Y, and the first duration are completely the same, partially the same, or completely different.

In S1304, a behavior of the SL terminal in the case where the synchronization source is unavailable is performed.

In some embodiments, the first synchronization source is the synchronization reference terminal. In some practices, in the case where the SL terminal measures the first synchronization source, an extension parameter of the measurement time duration exceeds a maximum extension parameter due to an LBT failure/the synchronization reference terminal being no longer located in the current region (invisible). In this case, the SL terminal in some practices endlessly re-measures the first synchronization source, resulting in high overheads of the SL terminal. The method according to the embodiments of the present disclosure introduces the fourth condition to stop the measurement of the synchronization source to avoid endless repeated measurements of the same synchronization source, and provides the behavior of the SL terminal in the case where the fourth condition is satisfied. The content is as follows.

In some embodiments, in the case where the first synchronization source is unavailable (the fourth condition being satisfied is considered as the first synchronization source being no longer located in the current region (invisible), rather than the LBT failure), the SL terminal stops measuring the first synchronization source.

In some embodiments, in the case where the first synchronization source is the synchronization source currently selected by the SL terminal, the SL terminal triggers synchronization source detection.

In some embodiments, in the case where the first synchronization source is the synchronization source currently selected by the SL terminal, the status of the SL terminal changes from having the first synchronization source (synchronization reference terminal) as the synchronization source to having no synchronization source.

In some embodiments, in the case where the first synchronization source is the synchronization source currently selected by the SL terminal, the SL terminal triggers transmission of a synchronization signal based on a local timing prior to selecting a second synchronization source. In some embodiments, the synchronization signal includes at least one of the SLSS or the S-SSB.

In some embodiments, in the case where the first synchronization source is a candidate synchronization source, the SL terminal detects and measures the second synchronization source.

In some embodiments, in the process of measuring the first synchronization source, in the case where the fourth condition is satisfied (which is considered as the first synchronization source being still located in the current region (visible) but the measurement being impossible due to excessive LBT failures), the SL terminal determines that the first synchronization source is available.

In some embodiments, in the case where the first synchronization source is available, the SL terminal continues to measure the first synchronization source. In this case, whether the first synchronization source has been selected as the synchronization source or is the candidate synchronization source is not considered.

In the embodiments, S1302 and S1304 are optional. In different embodiments, one or more of these processes are omitted or replaced.

S1302 may be implemented as an independent embodiment, for example, separately implemented as a method for measuring a synchronization source performed by the SL terminal. S1304 may be implemented as an independent embodiment, for example, separately implemented as a method for measuring a synchronization source performed by the SL terminal.

In summary, the method according to the embodiments determines, based on the fourth condition, whether the synchronization source measured by the SL terminal is available, and further determines, based on the determination result, whether to stop measuring the synchronization source, such that repeated measurements of the same synchronization source are avoided, and the overhead of the SL terminal is reduced. Moreover, the method according to the embodiments further clarifies the behavior of the SL terminal in the case where the fourth condition is satisfied and the behavior of the SL terminal in the case where the fourth condition is not satisfied.

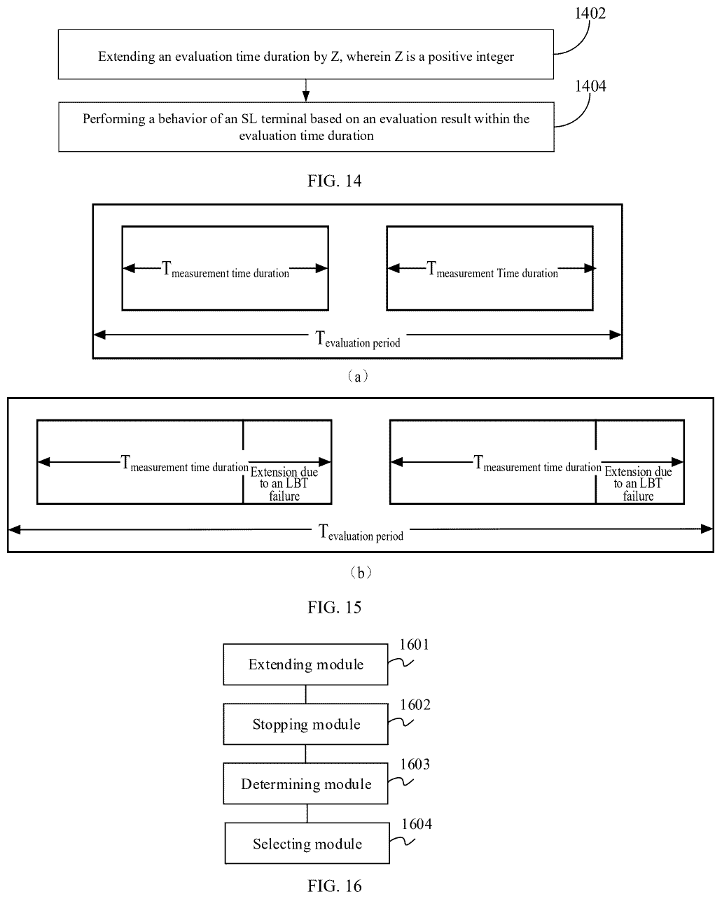

For the above solution (3), FIG. 14 is a flowchart of a method for evaluation according to some exemplary embodiments of the present disclosure. The method is performed by an SL terminal. The method includes the following processes.

In S1402, an evaluation time duration is extended by Z, wherein Z is a positive integer.

The evaluation time duration is used for evaluating a measurement result of a currently selected synchronization source in an SL-U, and an evaluation result is used for triggering transmission of a synchronization signal of the SL terminal. In some embodiments, the synchronization signal includes at least one of the SLSS or the S-SSB. Z is related to X, X is used for extending a measurement time duration to a maximum measurement time duration, and the measurement time duration is used for measuring the synchronization source. For descriptions of the measurement time duration and X, reference may be made to the embodiments illustrated in FIG. 6, which are not repeated herein in the present disclosure.

In some embodiments, Z is an even multiple of X. In some embodiments, Z is twice X.

The evaluation time duration includes a plurality of evaluation periods. In some embodiments, the evaluation period includes at least one of an SLSS period, an S-SSB period, or an SL-DRX cycle. In some embodiments, in the case where the SL terminal fails to evaluate the measurement result of the synchronization source within an un-extended evaluation time duration, the SL terminal extends the evaluation time duration in a unit of the evaluation period and continues the evaluation, to determine whether to trigger the transmission of the synchronization signal of the SL terminal.

In some embodiments, the evaluation time duration is represented as (4+x)*synchronization signal period or (4+x)*SL-DRX cycle. x represents a number of extensions of the evaluation periods, that is, the number of evaluation periods extended on the basis of four evaluation periods (evaluation time duration without extension). The number of extensions is equivalent to/replaceable with a number of extensions, that is, a maximum number of extended evaluation periods (extending by one evaluation period each time) on the basis of four evaluation periods. x<x_max. Here, x_max represents a maximum number of extensions of the evaluation periods. In some embodiments, x_max=2*y_max, where y_max represents X.

In S1404, a behavior of the SL terminal is performed based on an evaluation result within the evaluation time duration.

For the case where the synchronization source is evaluated as unavailable:

In some embodiments, in the case where the synchronization source is unavailable (which is considered as the synchronization source (synchronization reference terminal) being no longer located in the current region (invisible), rather than the LBT failure), the SL terminal considers that no synchronization source exists. In this case, the SL terminal triggers the transmission of the synchronization signal.

For the case where the synchronization source is evaluated as available:

In some embodiments, in the case where the synchronization source is available (which is considered as the synchronization source being still located in the current region (visible) but an accurate evaluation of the measurement result being impossible due to excessive LBT failures), the SL terminal maintains the current transmission behavior of the synchronization signal. For example, in the case where the SL terminal determines, based on a reliable measurement result, that the synchronization signal needs to be transmitted, the SL terminal continues to transmit the synchronization signal. Alternatively, the SL terminal determines, based on a latest valid measurement result, whether to transmit the synchronization signal. In some embodiments, the measurement result refers to the PSBCH-RSRP.

In some embodiments, in the case where the synchronization source is available, the SL terminal determines, based on a terminal capability, whether to transmit the synchronization signal. In some embodiments, the terminal capability is an existing terminal capability. For example, an SL terminal that needs to save energy chooses not to transmit the synchronization signal. In some embodiments, the terminal capability is a terminal capability newly introduced for the scenario.

In some embodiments, in the case where the synchronization source is available, the SL terminal determines, based on pre-configuration information or signaling from a network device, whether to transmit the synchronization signal.

In some embodiments, in the case where the synchronization source is available, the SL terminal determines, based on a synchronization source priority or a type of the synchronization source, whether to transmit the synchronization signal. In some embodiments, in the case where the synchronization source priority of the synchronization source is higher than a priority threshold, the synchronization signal is transmitted; or in the case where the synchronization source priority of the synchronization source is lower than the priority threshold, the synchronization signal is not transmitted.

In some embodiments, a manner of determining the priority threshold includes at least one of:
the priority threshold being predetermined;
the priority threshold being determined based on a terminal capability; or
the priority threshold being configured by a network device.

In some embodiments, in the case where the synchronization source is available, the SL terminal evaluates, using a currently inaccurate measurement, whether to transmit the synchronization signal.

In some embodiments, in the case where the synchronization source is available, the transmission of the synchronization signal is triggered. That is, regardless of the value of the measurement result, the transmission of the synchronization signal is triggered.

In some embodiments, the above behaviors of the SL terminal in the case where the synchronization source is available are freely combined and applied. For example, the SL terminal transmits the synchronization signal only in the case where signaling configuration and priority conditions are satisfied. The synchronization signal is not transmitted in the case where either of the conditions is not satisfied.

In some embodiments, the synchronization source being available includes a case where the measurement of the synchronization source fails to satisfy a measurement requirement (that is, the measurement result is unreliable). In some embodiments, the failure to satisfy the measurement requirement includes a case where an actual number of measurements for the synchronization source is less than a required number of measurements. For example, the requirement is to measure four periods, but the measurement is actually performed only within two periods.

For the above implementations of determining whether the synchronization source is available, reference may be made to the second condition in the embodiments illustrated in FIG. 6, which is not repeated herein in the present disclosure. It should be noted that, in the process of evaluating whether the synchronization source is available, in the case where the second condition in the embodiments illustrated in FIG. 6 is used for determination, the same or different numerical values as those of the second condition in the embodiments illustrated in FIG. 6 are used.

In some embodiments, the PSBCH-RSRP evaluation time duration is defined as (4+x)*evaluation period (S-SSB period). x should be less than x_max. In some embodiments, x_max=2*y_max. y_max represents y_max in the PSBCH-RSRP measurement in the measurement-related embodiments.

Typically, the evaluation time duration includes a plurality of measurement time durations. FIG. 15 is a schematic diagram of an evaluation time duration according to some exemplary embodiments of the present disclosure. As illustrated in FIG. 15, the evaluation time duration Tₑᵥₐₗᵤₐₜₑ in an SL is four S-SSB periods, including exactly two PSBCH-RSRP measurement time durations. In this case, extending the measurement time duration due to an LBT failure also needs to follow this rule. Therefore, x_max=2*y_max.

In the case where x exceeds x_max, the behavior of the SL terminal is as follows.

(1) Combined with the second condition in the foregoing embodiments:
a. In the case where the condition is satisfied, the PSBCH-RSRP of the current synchronization source (SyncRef UE) is not measured for a long time, and then it is considered that the synchronization source is no longer available. In this case, the SL terminal automatically triggers transmission of the synchronization signal.
b. In the case where the condition is not satisfied, the synchronization source continues to be re-measured. In this case, before an accurate PSBCH-RSRP evaluation result is acquired, the behavior of transmission of the synchronization signal includes at least one of the following behaviors:
i. The existing behavior is maintained, or a determination is performed based on a latest valid PSBCH-RSRP evaluation result. For example, in the case where the SL terminal measures an accurate PSBCH-RSRP within the first Tₑᵥₐₗᵤₐₜₑ period and determines that the synchronization signal needs to be transmitted, but fails to acquire an accurate evaluation result within the second Tₑᵥₐₗᵤₐₜₑ period due to an LBT failure, the existing behavior (i.e., transmitting the synchronization signal) is maintained until a valid PSBCH-RSRP result is measured, and whether to transmit the synchronization signal is re-determined based on the result.
ii. Whether to transmit the synchronization signal is determined based on a terminal capability.
1. The terminal capability refers to an existing capability. For example, an SL terminal that needs to save energy chooses not to transmit the synchronization signal.
2. A new terminal capability is introduced to indicate whether to transmit the synchronization signal in this case.
iii. Whether to transmit the synchronization signal is determined based on pre-configured or network-configured signaling. For example, the pre-configured or network-configured signaling TxSLSSwithInaccuratePSBCH-RSRP={true,false} is introduced. In this case (where no accurate PSBCH-RSRP evaluation result is acquired due to the LBT failure, but the synchronization terminal is not completely lost, corresponding to the case where the second condition is not satisfied), the SL terminal transmits the synchronization signal in the case where the signaling is true; or the SL terminal does not transmit the SLSS in the case where the signaling is false.
iv. Whether the synchronization signal needs to be transmitted is determined based on a priority/type of the synchronization source.
1. A priority threshold is introduced, for example, of 4. In the case where the priority of the synchronization source is higher than the threshold, the SL terminal chooses to transmit the synchronization signal to propagate the high-priority synchronization timing information. In the case where the priority of the synchronization source is lower, the SL terminal chooses not to transmit the synchronization signal.
2. The priority threshold value is pre-configured, network-configured, or determined based on a terminal capability.
3. The priority threshold value is set to different values based on configuration values: sl-SyncPriority={gnbEnb,gnss} and/or sl-NbAsSync={true,false}. N indicates whether a cell has a higher priority or the GNSS has a higher priority. K indicates whether a cell (NodeB) is used as the synchronization source.
v. The above solutions are combinable. For example, in the case of iii+iv, the SL terminal transmits the synchronization signal only in the case where signaling configuration and priority conditions are satisfied, that is, the signaling TxSLSSwithInaccuratePSBCH-RSRP is true and the priority of the synchronization source is higher than a specific threshold. The synchronization signal is not transmitted in the case where either of the conditions is not satisfied.
vi. The evaluation is performed using the currently inaccurate PSBCH-RSRP.
vii. Regardless of the value of the measured PSBCH-RSRP, the transmission of the synchronization signal is triggered.

It should be noted that although both cases a and b involve transmitting the synchronization signal (i.e., the SLSS), the transmitted objects are different. In the case a, the SL terminal triggers the transmission of the synchronization signal in the case where the SL terminal determines no synchronization source, the timing information is determined based on the local time of the synchronization terminal, a synchronization signal identifier (SLSSID) is randomly selected from an out-of-coverage set, and in-coverage information in an SL-master indication block (MIB) is set to false. In the case b, the SL terminal triggers the transmission of the synchronization signal in the case where the synchronization source (SyncRef UE) exists, the timing information comes from the synchronization source, and both an SLSSID and in-coverage information in an SL-MIB need to be configured by the synchronization source.

(2) With a new condition introduced instead of directly using the second condition:
a. The SL terminal should trigger the transmission of the synchronization signal as long as the current synchronization source is available.
b. The new condition is similar to the second condition but with different numerical values. For example, x_max is exceeded due to the LBT failure within Nx consecutive Tₑᵥₐₗᵤₐₜᵢₒₙ periods, such that the user fails to acquire an accurate PSBCH-RSRP evaluation result.
i. The Nx consecutive Tₑᵥₐₗᵤₐₜᵢₒₙ periods are replaceable with S-SSB periods or SL-DRX cycles.
ii. The value of Nx is predefined, network-configured, or determined based on a UE capability.
iii. The value of Nx depends on a priority/type of the current synchronization source.
c. The behavior of the SL terminal in the case where the condition is satisfied or not satisfied is the same as that in case (1).

In the embodiments, S1402 and S1404 are optional. In different embodiments, one or more of these processes are omitted or replaced.

S1402 may be implemented as an independent embodiment, for example, separately implemented as a method for evaluating a synchronization source performed by the SL terminal. S1404 may be implemented as an independent embodiment, for example, separately implemented as a method for evaluating a synchronization source performed by the SL terminal.

In summary, the method according to the embodiments clarifies the mode for extending the evaluation time duration in evaluating the synchronization source in the SL-U to clarify the manner of determining the evaluation time duration in the SL-U. By correlating the extension of the evaluation time duration with the measurement time duration, the mode for properly setting the evaluation time duration is provided, which helps clarify the related behaviors of the SL terminal through evaluation within the evaluation time duration. Moreover, the method according to the embodiments further clarifies the behavior of the SL terminal in different availability cases of the synchronization source.

It should be noted that the sequence of the method processes provided in the embodiments of the present disclosure may be appropriately adjusted, and the processes may be increased or decreased according to the situation, and different processes may be freely combined to form a new embodiment. Any variations of the method that may be envisaged by those skilled in the art within the technical scope disclosed herein also fall within the protection scope of the present disclosure and thus are not described herein. Moreover, the order of the different cases as described above does not have a preferred meaning, but is merely for convenience of description.

FIG. 16 is a block diagram of an apparatus for detection according to some exemplary embodiments of the present disclosure. The apparatus may be implemented as an SL terminal or a part of the SL terminal by software, hardware, or a combination thereof. The apparatus includes at least part of an extending module 1601, a stopping module 1602, a determining module 1603, and a selecting module 1604.

The extending module 1601 is configured to extend a detection time duration in the case where a first sampling result within the detection time duration does not satisfy a first condition, wherein the detection time duration is used for detecting a synchronization source via an SL-U. It should be noted that, in the embodiments of the present disclosure, detection is equivalent to/replaceable with discovery/probing.

In some embodiments, the types of objects that can be used as the synchronization source include at least one of the GNSS, a cell, or a synchronization reference terminal.

In some embodiments, the current synchronization source of the SL terminal is the synchronization reference terminal, and a synchronization source to which the synchronization reference terminal is directly or indirectly synchronized is synchronized to the synchronization source with the highest synchronization source priority. In this case, the scenario is referred to as a synchronous scenario. In some embodiments, the current synchronization source of the SL terminal is the synchronization reference terminal, and a synchronization source to which the synchronization reference terminal is directly or indirectly synchronized has a timing different from that of the synchronization source with the highest synchronization source priority. In this case, the scenario is referred to as an asynchronous scenario.

In some embodiments, the detection time duration includes one or more basic detection time durations, wherein the one or more basic detection time durations are used for extending the detection time duration. In some embodiments, the basic detection time duration includes at least one of:
one or more SLSS periods;
one or more S-SSB periods; or
one or more SL-DRX cycles.

It should be noted that, in the embodiments of the present disclosure, the detection time duration is equivalent to/replaceable with a detection duration, and the basic detection time duration is equivalent to/replaceable with a basic detection duration, a detection period cell, or a detection period unit. This is not limited in the embodiments of the present disclosure. It should be noted that, in the embodiments of the present disclosure, the S-SSB is equivalent to/replaceable with the SLSS.

In some embodiments, in the case where the detection time duration is not extended, the detection time duration includes one or more basic detection time durations, for example, includes only one basic detection time duration. The basic detection time duration is used for extending the detection time duration, for example, extending the detection time duration in a unit of the basic detection time duration.

In some embodiments, each basic detection time duration includes one or more detection periods. The detection period includes at least one of an SLSS period, an S-SSB period, or an SL-DRX cycle. In some embodiments, the first sampling result includes a sampling result for a synchronization signal. The synchronization signal is transmitted by the synchronization source and is used for detecting the synchronization source. In some embodiments, the measurement result is equivalent to/replaceable with a detection result. The synchronization signal includes at least one of:
an SLSS; or
an S-SSB.

In some embodiments, the detection time duration includes a plurality of basic detection time durations, and the first sampling result is determined based on a second sampling result within each of the plurality of basic detection time durations. In some embodiments, in the case where the un-extended detection time duration includes one basic detection time duration, the case where the detection time duration includes the plurality of basic detection time durations is acquired by extending the un-extended detection time duration. In this case, the detection time duration including the plurality of basic detection time durations is an extended detection time duration.

In some embodiments, the extending module 1601 is configured to:
extend the detection time duration by m basic detection time durations of the plurality of basic detection time durations in the case where the first sampling result within the detection time duration does not satisfy the first condition, where m is a positive integer. In some embodiments, m equals 1.

In some embodiments, the apparatus further includes:
the stopping module 1602, configured to stop extending the detection time duration in the case where the first sampling result within the detection time duration satisfies the first condition.

In some embodiments, the first sampling result includes a sampling result for a synchronization signal, and each of the plurality of basic detection time durations is used for sampling the synchronization signal for n times, wherein n is a positive integer. In some embodiments, n equals 3. In some embodiments, in synchronization signal sampling within the basic detection time duration, the SL terminal randomly selects n detection periods to perform sampling for n times.

In some embodiments, a number of extensions corresponding to the detection time duration is less than N, wherein the number of extensions is a cumulative number of times that the detection time duration has been extended by the basic detection time duration. The number of extensions is equivalent to/replaceable with an extension quantity, and the number of extensions is a cumulative number of times that the detection time duration has been extended by the basic detection time duration.

In some embodiments, the apparatus further includes:
the determining module 1603, configured to determine that the synchronization source is not detected in the case where the number of extensions is greater than N.

In some embodiments, the extending module 1601 is configured to:
extend the detection time duration by N basic detection time durations in the case where the first sampling result within the detection time duration does not satisfy the first condition, wherein an extended detection time duration includes (N+1) basic detection time durations. In some embodiments, the detection time duration prior to extension includes only one basic detection time duration.

In some embodiments, the first sampling result includes a sampling result for a synchronization signal, and each of the one or more basic detection time durations includes one or more detection periods; and the apparatus further includes:

the selecting module 1604, configured to select (1+N)*n detection periods from the (N+1) basic detection time durations for performing synchronization signal sampling, wherein n is a positive integer. In some embodiments, the numbers of detection periods selected by the SL terminal within different basic detection time durations are the same or different. In some embodiments, n equals 3.

In some embodiments, the apparatus further includes:
the determining module 1603, configured to determine that the synchronization source is not detected in the case where sampling results within the (N+1) basic detection time durations do not satisfy the first condition.

In some embodiments, the first condition includes at least one of:
a cumulative sampling number for the synchronization signal within the detection time duration is greater than or equal to K; or
a time interval between two consecutive synchronization signal samplings does not exceed P, where P is a positive integer.

In some embodiments, the two consecutive synchronization signal samplings refer to any two consecutive synchronization signal samplings in a plurality of synchronization signal samplings that satisfy the cumulative sampling number.

In some embodiments, N is related to an SL-DRX configuration. In some embodiments, in the case of non-SL-DRX or in a case where an SL-DRX cycle is less than a first value, N is a first numerical value. In some embodiments, in the case where an SL-DRX cycle is greater than a first value, N is a second numerical value.

In some embodiments, N is related to a synchronization source priority of a current synchronization source of the SL terminal. In some embodiments, in the case where the current synchronization source of the SL terminal is the synchronization reference terminal, and a synchronization source to which the synchronization reference terminal is directly or indirectly synchronized is synchronized to the synchronization source with the highest synchronization source priority, N is the first numerical value. In some embodiments, in the case where the current synchronization source of the SL terminal is the synchronization reference terminal, and a synchronization source to which the synchronization reference terminal is directly or indirectly synchronized has a timing different from that of the synchronization source with the highest synchronization source priority, N is a third numerical value. In some embodiments, the third numerical value is different from the first numerical value and the second numerical value. For example, the third numerical value is greater than the first numerical value.

In some embodiments, a manner of determining K includes at least one of:
K being predetermined;
K being determined based on a terminal capability; or
K being configured by a network device.

In some embodiments, a manner of determining P includes at least one of:
P being predetermined;
P being determined based on a terminal capability; or
P being configured by a network device.

In some embodiments, the apparatus according to the embodiments of the present disclosure includes one extending module 1601. The extending module 1601 supports performing all the extension-related processes performed by the SL terminal in the above embodiments.

In some embodiments, the apparatus according to the embodiments of the present disclosure includes a plurality of extending modules 1601. The plurality of extending modules 1601 respectively support performing part of the extension-related processes performed by the SL terminal in the above embodiments.

In some embodiments, the processes performed by different extending modules 1601 are completely the same, partially the same, or completely different.

In some embodiments, the apparatus according to the embodiments of the present disclosure includes one stopping module 1602. The stopping module 1602 supports performing all the stopping-related processes performed by the SL terminal in the above embodiments.

In some embodiments, the apparatus according to the embodiments of the present disclosure includes a plurality of stopping modules 1602. The plurality of stopping modules 1602 respectively support performing part of the stopping-related processes performed by the SL terminal in the above embodiments.

In some embodiments, the processes performed by different stopping modules 1602 are completely the same, partially the same, or completely different.

In some embodiments, the apparatus according to the embodiments of the present disclosure includes one determining module 1603. The determining module 1603 supports performing all the determination-related processes performed by the SL terminal in the above embodiments.

In some embodiments, the apparatus according to the embodiments of the present disclosure includes a plurality of determining modules 1603. The plurality of determining modules 1603 respectively support performing part of the determination-related processes performed by the SL terminal in the above embodiments.

In some embodiments, the processes performed by different determining modules 1603 are completely the same, partially the same, or completely different.

In some embodiments, the apparatus according to the embodiments of the present disclosure includes one selecting module 1604. The selecting module 1604 supports performing all the selection-related processes performed by the SL terminal in the above embodiments.

In some embodiments, the apparatus according to the embodiments of the present disclosure includes a plurality of selecting modules 1604. The plurality of selecting modules 1604 respectively support performing part of the selection-related processes performed by the SL terminal in the above embodiments.

In some embodiments, the processes performed by different selecting modules 1604 are completely the same, partially the same, or completely different.

In summary, the apparatus according to the embodiments clarifies the manner of determining the detection time duration in the SL-U by clarifying the mode for extending the detection time duration in detecting the synchronization source in the SL-U, and thus provides the implementation of detecting the synchronization source in the SL-U.

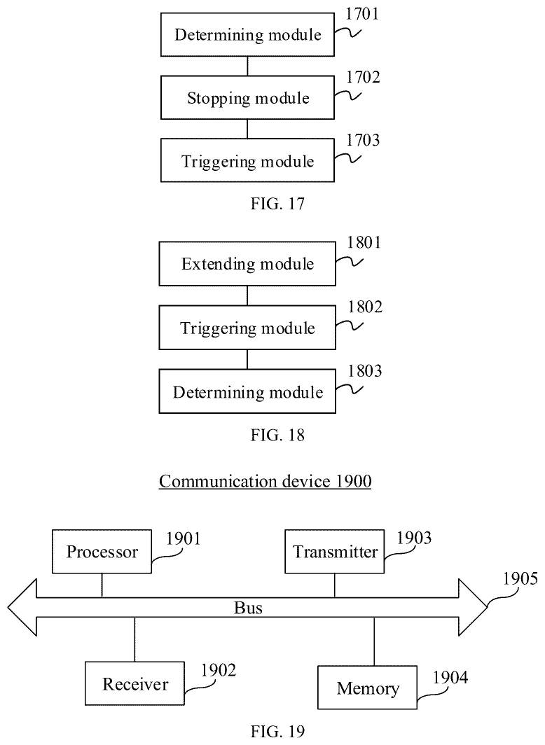

FIG. 17 is a block diagram of an apparatus for measurement according to some exemplary embodiments of the present disclosure. The apparatus may be implemented as an SL terminal or a part of the SL terminal by software, hardware, or a combination thereof. The apparatus includes at least part of a determining module 1701, a stopping module 1702, and a triggering module 1703.

The determining module 1701 is configured to determine, in a process of measuring a first synchronization source in an SL-U, that the first synchronization source is unavailable in the case where a second condition is satisfied.

In some embodiments, the second condition includes at least one of:
no measurement result being measured within Q consecutive maximum measurement time durations, wherein the maximum measurement time duration is acquired by extending a measurement time duration by X;
no measurement result being measured within Y consecutive measurement periods, where each measurement time duration includes a plurality of measurement periods; or
no measurement result being measured within a first duration.

In some embodiments, the maximum measurement time duration includes a plurality of measurement periods. In some embodiments, the measurement period includes at least one of an SLSS period, an S-SSB period, or an SL-DRX cycle. In some embodiments, in the case where the SL terminal measures no measurement result within an un-extended measurement time duration, the SL terminal extends the measurement time duration in a unit of the measurement period and continues the measurement. Then, in the case where the measurement time duration is extended to the maximum measurement time duration but no measurement result is measured, the SL terminal performs the measurement again in the above manner. In some embodiments, the above second condition is used for determining whether to stop measuring the first synchronization source.

In some embodiments, the maximum measurement time duration is acquired by extending the measurement time duration by a maximum number of measurement periods. In some embodiments, measuring the first synchronization source refers to measuring a PSBCH-RSRP of the first synchronization source.

In some embodiments, the maximum measurement time duration is represented as (2+y_max)*160 or (2+y_max)*SL-DRX cycle. 160 refers to the SLSS period, and y_max represents a maximum number of extensions, that is, a maximum number of measurement periods extended on the basis of two measurement periods (measurement time duration without extension). The maximum number of extensions is equivalent to/replaceable with a maximum extension quantity, that is, a maximum quantity of extended measurement periods (extending by one measurement period each time) on the basis of two measurement periods (measurement time duration without extension). In some embodiments, y_max=2.

In some embodiments, the apparatus further includes:

the stopping module 1702, configured to stop measuring the first synchronization source in the case where the first synchronization source is unavailable.

In some embodiments, the apparatus further includes:

the triggering module 1703, configured to trigger synchronization source detection in the case where the first synchronization source is a synchronization source currently selected by the SL terminal.

In some embodiments, the apparatus further includes:
the triggering module 1703, configured to trigger, in the case where the first synchronization source is a synchronization source currently selected by the SL terminal, transmission of a synchronization signal based on a local timing prior to selecting a second synchronization source.

In some embodiments, the apparatus further includes:
the triggering module 1703, configured to detect and measure a second synchronization source in the case where the first synchronization source is a candidate synchronization source.

In some embodiments, the determining module 1701 is configured to:
determine, in the process of measuring the first synchronization source, that the first synchronization source is available in the case where the second condition is not satisfied.

In some embodiments, a manner of determining Q (Q is a positive integer) includes at least one of:
Q being predetermined;
Q being determined based on a terminal capability;
Q being configured by a network device;
Q being determined based on a synchronization source priority or a type of the first synchronization source; or
Q being determined based on a synchronization source priority or a type of the synchronization source currently selected by the SL terminal.

In some embodiments, a manner of determining Y includes at least one of:
Y being predetermined;
Y being determined based on a terminal capability;
Y being configured by a network device;
Y being determined based on a synchronization source priority or a type of the first synchronization source; or
Y being determined based on a synchronization source priority or a type of the synchronization source currently selected by the SL terminal.

In some embodiments, a manner of determining the first duration includes at least one of: the first duration being predetermined;
the first duration being determined based on a terminal capability;
the first duration being configured by a network device;
the first duration being determined based on a synchronization source priority or a type of the first synchronization source; or
the first duration being determined based on a synchronization source priority or a type of the synchronization source currently selected by the SL terminal.

In some embodiments, the apparatus according to the embodiments of the present disclosure includes one determining module 1701. The determining module 1701 supports performing all the determination-related processes performed by the SL terminal in the above embodiments.

In some embodiments, the apparatus according to the embodiments of the present disclosure includes a plurality of determining modules 1701. The plurality of determining modules 1701 respectively support performing part of the determination-related processes performed by the SL terminal in the above embodiments.

In some embodiments, the processes performed by different determining modules 1701 are completely the same, partially the same, or completely different.

In some embodiments, the apparatus according to the embodiments of the present disclosure includes one stopping module 1702. The stopping module 1702 supports performing all the stopping-related processes performed by the SL terminal in the above embodiments.

In some embodiments, the apparatus according to the embodiments of the present disclosure includes a plurality of stopping modules 1702. The plurality of stopping modules 1702 respectively support performing part of the stopping-related processes performed by the SL terminal in the above embodiments.

In some embodiments, the processes performed by different stopping modules 1702 are completely the same, partially the same, or completely different.

In some embodiments, the apparatus according to the embodiments of the present disclosure includes one triggering module 1703. The triggering module 1703 supports performing all the triggering-related processes performed by the SL terminal in the above embodiments.

In some embodiments, the apparatus according to the embodiments of the present disclosure includes a plurality of triggering modules 1703. The plurality of triggering modules 1703 respectively support performing part of the triggering-related processes performed by the SL terminal in the above embodiments.

In some embodiments, the processes performed by different triggering modules 1703 are completely the same, partially the same, or completely different.

In summary, the apparatus according to the embodiments determines, based on the second condition, whether the synchronization source measured by the SL terminal is available, and further determines, based on the determination result, whether to stop measuring the synchronization source, such that repeated measurements of the same synchronization source are avoided, and the overhead of the SL terminal is reduced.

FIG. 18 is a block diagram of an apparatus for evaluation according to some exemplary embodiments of the present disclosure. The apparatus may be implemented as an SL terminal or a part of the SL terminal by software, hardware, or a combination thereof. The apparatus includes at least part of an extending module 1801, a triggering module 1802, and a determining module 1803.

The extending module 1801 is configured to extend an evaluation time duration by Z, where the evaluation time duration is used for evaluating a measurement result of a currently selected synchronization source in an SL-U, and an evaluation result is used for triggering transmission of a synchronization signal, and Z is related to X, wherein X is used for extending a measurement time duration to a maximum measurement time duration, and the measurement time duration is used for measuring the synchronization source. For descriptions of the measurement time duration and X, reference may be made to the embodiments illustrated in FIG. 6, which are not repeated herein in the present disclosure.

The evaluation time duration includes a plurality of evaluation periods. In some embodiments, the evaluation period includes at least one of an SLSS period, an S-SSB period, or an SL-DRX cycle. In some embodiments, in the case where the SL terminal cannot evaluate the measurement result of the synchronization source within an un-extended evaluation time duration, the SL terminal extends the evaluation time duration in a unit of the evaluation period and continues the evaluation, to determine whether to trigger the transmission of the synchronization signal of the SL terminal.

In some embodiments, the evaluation time duration is represented as (4+x)*synchronization signal period or (4+x)*SL-DRX cycle. x represents a number of extensions of the evaluation periods, that is, the number of evaluation periods extended on the basis of four evaluation periods (evaluation time duration without extension). The number of extensions is equivalent to/replaceable with an extension quantity, that is, a maximum quantity of extended evaluation periods (extending by one evaluation period each time) on the basis of four evaluation periods. x<x_max. Here, x_max represents a maximum number of extensions of the evaluation periods. In some embodiments, x_max=2y_max, and y_max represents X.

In some embodiments, the apparatus further includes:
the triggering module 1802, configured to trigger the transmission of the synchronization signal in the case where the synchronization source is unavailable.

In some embodiments, the synchronization source being available includes two cases: (1) The synchronization source is measurable each time. In this case, the SL terminal directly determines whether to transmit the synchronization signal by comparing the measured RSRP result to a threshold value. (2) Although the RSRP result of the synchronization source is measured, the measurement of the synchronization source fails to satisfy a measurement requirement (that is, the measurement result is unreliable). In some embodiments, the failure to satisfy the measurement requirement includes a case where an actual number of measurements for the synchronization source is less than a required number of measurements. For example, the requirement is four periods, but the measurement is actually performed only within two periods. The following behaviors of the SL terminal according to the embodiments of the present disclosure is applicable to case (2). It should be noted that, the following behaviors of the SL terminal according to the embodiments of the present disclosure are also applicable to case (1).

In some embodiments, the apparatus further includes:
the determining module 1803, configured to maintain a current transmission behavior of the synchronization signal or determine, based on a latest valid measurement result, whether to transmit the synchronization signal in the case where the synchronization source is available.

In some embodiments, the apparatus further includes:
the determining module 1803, configured to determine, based on a terminal capability, whether to transmit the synchronization signal in the case where the synchronization source is available.

In some embodiments, the apparatus further includes:
the determining module 1803, configured to determine, based on pre-configuration information or signaling from a network device, whether to transmit the synchronization signal in the case where the synchronization source is available.

In some embodiments, the apparatus further includes:
the determining module 1803, configured to determine, based on a synchronization source priority or a type of the synchronization source, whether to transmit the synchronization signal in the case where the synchronization source is available.

In some embodiments, the determining module 1803 is configured to:
transmit the synchronization signal in the case where the synchronization source priority of the synchronization source is higher than a priority threshold; and
refrain from transmitting the synchronization signal in the case where the synchronization source priority of the synchronization source is lower than the priority threshold.

In some embodiments, a manner of determining the priority threshold includes at least one of:
the priority threshold being predetermined;
the priority threshold being determined based on a terminal capability; or
the priority threshold being configured by a network device.

In some embodiments, the synchronization source being available includes a case where an actual number of measurements for the synchronization source is less than a required number of measurements.

In some embodiments, Z is an even multiple of X.

In some embodiments, Z is twice X.

In some embodiments, the synchronization signal includes at least one of:
an SLSS; or
an S-SSB.

In some embodiments, in the case where the synchronization source is available, whether to transmit the synchronization signal is evaluated using a currently inaccurate measurement.

In some embodiments, in the case where the synchronization source is available, the transmission of the synchronization signal is triggered. That is, regardless of the value of the measurement result, the transmission of the synchronization signal is triggered.

In some embodiments, the above behaviors in the case where the synchronization source is available are freely combined and applied. For example, the synchronization signal is transmitted only in the case where both signaling configuration and priority conditions are met. The synchronization signal is not transmitted in the case where either of the conditions is not satisfied.

In some embodiments, the apparatus according to the embodiments of the present disclosure includes one extending module 1801. The extending module 1801 supports performing all the extension-related processes performed by the SL terminal in the above embodiments.

In some embodiments, the apparatus according to the embodiments of the present disclosure includes a plurality of extending modules 1801. The plurality of extending modules 1801 respectively support performing part of the extension-related processes performed by the SL terminal in the above embodiments.

In some embodiments, the processes performed by different extending modules 1801 are completely the same, partially the same, or completely different.

In some embodiments, the apparatus according to the embodiments of the present disclosure includes one triggering module 1802. The triggering module 1802 supports performing all the triggering-related processes performed by the SL terminal in the above embodiments.

In some embodiments, the apparatus according to the embodiments of the present disclosure includes a plurality of triggering modules 1802. The plurality of triggering modules 1802 respectively support performing part of the triggering-related processes performed by the SL terminal in the above embodiments.

In some embodiments, the processes performed by different triggering modules 1802 are completely the same, partially the same, or completely different.

In some embodiments, the apparatus according to the embodiments of the present disclosure includes one determining module 1803. The determining module 1803 supports performing all the determination-related processes performed by the SL terminal in the above embodiments.

In some embodiments, the apparatus according to the embodiments of the present disclosure includes a plurality of determining modules 1803. The plurality of determining modules 1803 respectively support performing part of the determination-related processes performed by the SL terminal in the above embodiments.

In some embodiments, the processes performed by different determining modules 1803 are completely the same, partially the same, or completely different.

In summary, the apparatus according to the embodiments clarifies the mode for extending the evaluation time duration in evaluating the synchronization source in the SL-U to clarify the manner of determining the evaluation time duration in the SL-U. By correlating the extension of the evaluation time duration with the measurement time duration, a mode for properly setting the evaluation time duration is provided, which helps clarify the related behaviors of the SL terminal through evaluation in the evaluation time duration.

It should be noted that in the case where the apparatus according to the above embodiments implements the functions thereof, the division of the functional modules is merely exemplary. In practical applications, the above functions may be assigned to different functional modules according to actual needs, that is, the internal structure of the device may be divided into different functional modules to implement all or a part of the above functions.

With regard to the apparatus in the above embodiments, the specific manner in which each module performs the operations has been described in detail in the embodiments related to the method and will not be described in detail herein.

FIG. 19 is a schematic structural diagram of a communication device according to some exemplary embodiments of the present disclosure. The communication device is an SL terminal, and includes a processor 1901, a receiver 1902, a transmitter 1903, a memory 1904, and a bus 1905.

The processor 1901 includes one or more processing cores, and the processor 1901 executes various functional applications and performs information processing by running software programs and modules.

The receiver 1902 and the transmitter 1903 may be implemented as a communication assembly, which may be a communication chip.

The memory 1904 is connected to the processor 1901 via the bus 1905. The memory 1904 is configured to store at least one instruction, and the processor 1901 is configured to execute the at least one instruction to perform the processes in the above method embodiments.

In addition, the memory 1904 may be implemented by any type or combination of volatile or non-volatile storage devices including, but not limited to: magnetic or optical disks, electrically erasable programmable read-only memories (EEPROMs), erasable programmable read-only memories (EPROMs), static random access memories (SRAMs), read-only memories (ROMs), magnetic memories, flash memories, and programmable read-only memories (PROMs).

In some embodiments, the processor 1901 is configured to extend a detection time duration in the case where a first sampling result within the detection time duration does not satisfy a first condition, wherein the detection time duration is used for detecting a synchronization source via an SL-U. In some embodiments, the processor 1901 is further configured to perform other processes related to detection processing in the above method embodiments.

In some embodiments, the processor 1901 is configured to determine, in a process of measuring a first synchronization source in an SL-U, that the first synchronization source is unavailable in the case where a second condition is satisfied. In some embodiments, the processor 1901 is further configured to perform other processes related to measurement processing in the above method embodiments.

In some embodiments, the processor 1901 is configured to extend an evaluation time duration by Z, wherein the evaluation time duration is used for evaluating a measurement result of a currently selected synchronization source in an SL-U, an evaluation result is used for triggering transmission of a synchronization signal, and Z is related to X, wherein X is used for extending a measurement time duration to a maximum measurement time duration, and the measurement time duration is used for measuring the synchronization source. In some embodiments, the processor 1901 is further configured to perform other processes related to evaluation processing in the above method embodiments.

In some embodiments, the receiver 1902 independently receives signals/data, or the processor 1901 controls the receiver 1902 to receive signals/data, or the processor 1901 requests the receiver 1902 to receive signals/data, or the processor 1901 cooperates with the receiver 1902 to receive signals/data.

In some embodiments, the transmitter 1903 independently transmits signals/data, or the processor 1901 controls the transmitter 1903 to transmit signals/data, or the processor 1901 requests the transmitter 1903 to transmit signals/data, or the processor 1901 cooperates with the transmitter 1903 to transmit signals/data.

In some embodiments, the processor 1901 and the receiver 1902 are implemented as one module, or the processor 1901 is implemented as a part of the receiver 1902.

In some embodiments, the receiver 1902 is implemented as a receiver unit. In some embodiments, the receiver unit includes or does not include the processor 1901.

In some embodiments, the processor 1901 and the transmitter 1903 are implemented as one module, or the processor 1901 is implemented as a part of the transmitter 1903.

In some embodiments, the transmitter 1903 is implemented as a transmitter unit. In some embodiments, the transmitter unit includes or does not include the processor 1901.

In some exemplary embodiments, a computer-readable storage medium is further provided. The computer-readable storage medium stores at least one instruction, at least one program, a code set, or an instruction set therein. The at least one instruction, the at least one program, the code set, or the instruction set, when loaded and executed by a processor, causes the processor to perform the method for detection, the method for measurement, or the method for evaluation according to the above method embodiments.

In some exemplary embodiments, a chip is further provided. The chip includes programmable logic circuitry and/or one or more program instructions. The chip, when running the programmable logic circuitry and/or the one or more programs on a communication device, is caused to perform the method for detection, the method for measurement, or the method for evaluation according to the above method embodiments.

In some exemplary embodiments, a computer program product is further provided. The computer program product, when running on a processor of a computer device, causes the computer device to perform the method for detection, the method for measurement, or the method for evaluation as described above.

In some exemplary embodiments, a computer program is further provided. The computer program includes one or more computer instructions. The one or more computer instructions, when loaded and executed by a processor of a computer device, cause the computer device to perform the method for detection, the method for measurement, or the method for evaluation as described above.

A person skilled in the art should be aware that in the foregoing one or more examples, the functions described in the embodiments of the present disclosure may be implemented by hardware, software, firmware, or any combination thereof. When implemented by software, the functions may be stored in a computer-readable medium or transmitted as at least one instruction or code in the computer-readable medium. The computer-readable medium includes a computer storage medium and a communication medium. The communication medium includes any medium that facilitates transfer of a computer program from one place to another. The storage medium may be any usable medium accessible by a general-purpose computer or a special-purpose computer.

The foregoing descriptions are merely embodiments of the present disclosure and are not intended to limit the present disclosure. Any modification, equivalent replacement, and improvement within the spirit and principle of the present disclosure shall be included within the protection scope of the present disclosure.

1. A method for detection, performed by a sidelink (SL) terminal, the method comprising:
extending a detection time duration in a case where a first sampling result within the detection time duration does not satisfy a first condition, wherein the detection time duration is used for detecting a synchronization source via an unlicensed SL (SL-U).

2. The method according to claim 1, wherein the detection time duration comprises one or more basic detection time durations, wherein the one or more basic detection time durations are used for extending the detection time duration.

3. The method according to claim 2, wherein the detection time duration comprises a plurality of basic detection time durations, and the first sampling result is determined based on a second sampling result within each of the plurality of basic detection time durations.

4. The method according to claim 3, wherein extending the detection time duration in the case where the first sampling result within the detection time duration does not satisfy the first condition comprises:
extending the detection time duration by m basic detection time durations of the plurality of basic detection time durations in the case where the first sampling result within the detection time duration does not satisfy the first condition, wherein m is a positive integer.

5. The method according to claim 3, further comprising:
stopping extending the detection time duration in a case where the first sampling result within the detection time duration satisfies the first condition.

6. The method according to claim 4, wherein the first sampling result comprises a sampling result for a synchronization signal, and each of the plurality of basic detection time durations is used for sampling the synchronization signal for n times, wherein n is a positive integer.

7. The method according to claim 4, wherein a number of extensions corresponding to the detection time duration is less than N, wherein the number of extensions is a cumulative number of times that the detection time duration has been extended by the basic detection time duration, and N is a positive integer.

8. The method according to claim 7, further comprising:
determining that the synchronization source is not detected in a case where the number of extensions is greater than N.

9. The method according to claim 2, wherein extending the detection time duration in the case where the first sampling result within the detection time duration does not satisfy the first condition comprises:
extending the detection time duration by N basic detection time durations in the case where the first sampling result within the detection time duration does not satisfy the first condition, wherein an extended detection time duration comprises (N+1) basic detection time durations.

10. The method according to claim 9, wherein the first sampling result comprises a sampling result for a synchronization signal, and each of the one or more basic detection time durations comprises one or more detection periods; and the method further comprises:
selecting (N+1)*n detection periods from the (N+1) basic detection time durations for performing synchronization signal sampling, wherein n is a positive integer.

11. The method according to claim 9, further comprising:
determining that the synchronization source is not detected in a case where sampling results within the (N+1) basic detection time durations do not satisfy the first condition.

12. The method according to claim 6, wherein the first condition comprises at least one of:
a cumulative sampling number for the synchronization signal within the detection time duration is greater than or equal to K, wherein K is a positive integer; or
a time interval between two consecutive synchronization signal samplings does not exceed P, wherein P is a positive integer.

13. The method according to claim 7, wherein N is related to an SL discontinuous reception (SL-DRX) configuration.

14. The method according to claim 13, wherein in a case of non-SL-DRX or in a case where an SL-DRX cycle is less than a first value, N is a first numerical value.

15. The method according to claim 13, wherein in a case where an SL-DRX cycle is greater than a first value, N is a second numerical value.

16. The method according to claim 7, wherein N is related to a synchronization source priority of a current synchronization source of the SL terminal.

17. The method according to claim 12, wherein
a manner of determining K comprises at least one of: K being predetermined; K being determined based on a terminal capability; or K being configured by a network device; and
a manner of determining P comprises at least one of: P being predetermined; P being determined based on a terminal capability; or P being configured by a network device.

18. The method according to claim 6, wherein the synchronization signal comprises at least one of:
an SL synchronization signal (SLSS); or
an SL synchronization signal block (S-SSB).

19. The method according to claim 2, wherein the one or more basic detection time durations comprise at least one of:
one or more SL synchronization signal (SLSS) periods;
one or more SL synchronization signal block (S-SSB) periods; or
one or more SL discontinuous reception (SL-DRX) cycles.

20. A sidelink (SL) terminal, comprising:
a processor;
a transceiver, connected to the processor; and
a memory, configured to store one or more executable instructions of the processor,
wherein the processor is configured to extend a detection time duration in a case where a first sampling result within the detection time duration does not satisfy a first condition, wherein the detection time duration is used for detecting a synchronization source via an unlicensed SL (SL-U).
